(19) United States
(12) Patent Application Publication
(10) Pub. No.: US 2025/0131424 A1
(43) Pub. Date: Apr. 24, 2025

(54) SYSTEMS AND METHODS FOR INTEGRATING ISSUING PROCESSOR COMPUTING SYSTEMS OVER A COMMUNICATIONS NETWORK

(71) Applicant: Simnang IP, LLC, Farmington, UT (US)

(72) Inventor: Rhett M. Roberts, Kaysville, UT (US)

(21) Appl. No.: 18/490,981

(22) Filed: Oct. 20, 2023

(51) Int. Cl. G06Q 20/38; G06Q 20/40

(52) U.S. Cl. CPC G06Q 20/389; G06Q 20/401

(57) ABSTRACT

Systems, methods, and computer-readable storage media for integrating issuing processor computing systems over a communications network are provided. A connection can be established with a remote computing device over a communications network. One or more parameters of a card program and a pointer to a computing device of a computing system can be received. A data object can be generated. An event regarding an exchange card can be detected. A message regarding the event can be transmitted to the computing device of the computing system using the pointer. The computing device can forward data of the message to an issuing processor computing system.

### BACKGROUND

The present disclosure relates generally to the field of integrating issuing processor computing systems over a communications network. In a computer networked environment, such as the Internet, users and entities, such as people or companies, participate in exchanges (e.g., transactions). Individual exchanges can involve network communication within a complex backend computing network involving different computing systems that are configured to perform different roles to complete the exchange. In one example, various issuing processors can interface with different card networks to effect exchanges. The issuing processors can implement varying functionality, operations, or data conveyances. For example, one issuing processor can implement a function differently, omit a function, or implement different or additional functions compared with another issuing processor. Examples of such functions can include processing exchanges, issuing new cards, conveying various information between systems, etc.

### SUMMARY

Systems and methods are disclosed for integrating issuing processor computing systems, for example, with a computing application. A third-party computing system, which may desire to integrate into or with the computing application, may have an existing integration or connection with an issuing processor computing system. The systems and methods disclosed enable the third-party computing system to bring the issuing processor, by providing for integrating the issuing processor computing system with or into the computing application.

### BRIEF DESCRIPTION OF THE DRAWINGS

FIG. 1 is a block diagram depicting an implementation of a system including an issuing processor aggregator, according to some implementations.

FIG. 2 is a system architecture for aggregating issuing processors, according to some implementations.

FIG. 3 is a block diagram of an issuing processor aggregator interface of an issuing processor aggregator, according to some implementations.

FIG. 4 is a flowchart of a method to manage exchanges, according to some implementations.

FIG. 5 is a flowchart of a method to generate a card, according to some implementations.

FIG. 6 is a flow diagram depicting card generation, according to some implementations.

FIG. 7 is a flow diagram depicting exchange management, according to some implementations.

FIG. 8 is a system architecture for integrating an issuing processor computing system, according to some implementations.

FIG. 9 is a flowchart of a method to integrate an issuing processor computing system, according to some implementations.

FIGS. 10-19 illustrate user interfaces to integrate an issuing processor computing system, according to some implementations.

FIG. 20 is a block diagram illustrating an example computing system suitable for use in the various implementations described herein.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

The systems and methods described herein relate to issuer aggregation. A system can connect to different issuing processors that each have their own systems for card management. Card management can include card creation (e.g., issuing/instantiation) or other card administration such as changes to daily spend limits, whitelisted/blacklisted merchant category codes, address changes, card expiry management, or so forth. Card management can be performed incident to one or more card programs. For example, a card management function can be defined by or based on the card program. Each issuing processor can support or implement different features. For example, some issuing processors can implement varying exchange hold periods (e.g., 3 days, 7 days, or a dynamic hold based on various risk parameters). Similarly, some issuing processors can implement partial or incremental authorizations such as to process an amount less than a requested amount. Further, some issuing processors can implement varying settlement periods, chargeback handling data, fraud management or scoring, webhooks for technical integration, or so forth. Moreover, some issuing processors can include one or more reward or loyalty programs, which can include a provision of information related to a purchased item (e.g., to distinguish between an exchange, or portion thereof, associated with a purchase of retail merchandise from a gift card, stamp, service, or other exchange item, wherein the reward or loyalty program may discriminate therebetween).

Each issuing processor can include issuer entities (e.g., data structures). The issuer entities can have one or more data fields associated with features which are exclusive thereto, or which are uncommon to other issuing processors. For example, an issuer entity can include differently formatted, additional, lesser, or different data fields corresponding to varying features. Thus, a field of a uniform interface may not correspond to a field of an issuer entity. For example, a uniform interface can include a zip code field; an issuer entity can include a latitude and longitude of an exchange (e.g., a transaction), which can be used in combination with a card present bit indication to determine an exchange location, which may not include a zip code. Systems which do not include corresponding fields may not provide fields necessary to various operations such as authorizing, modifying, or settling exchanges, issuing or cancelling cards, or so forth. In another example, the issuer entity can include a travel notification, card embossing text or information, loyalty program ID which may not be present at the uniform interface. An issuing processor integration interface can include a connection to a data source, such as a data enrichment server to generate information not directly available from the proprietary system or the issuing processor. An issuing processor integration interface can effect various transformations, concatenations, supplementations, or other operations to translate information exchanged between different issuing processors and the proprietary system.

Various systems, such as a proprietary system including an electronic ledger, can interface with the various issuing processors. Such systems may be designed according to a tightly coupled interface. For example, in addition to implementation details to connect the interfaces, some information associated with an issuing processor may be absent at an electronic ledger, and some information associated with the electronic ledger may be absent as received from an issuing processor. For example, the electronic ledger can include a nested set of relationships between programs, cardholders, exchanges, or so forth, such that the operation of the electronic ledger depends upon a receipt of issuer entity data. Such tightly coupled interfaces may not be readily or practically ported to other issuing processors, or may face difficulties in connecting to an exchange network (e.g., card network). For example, an issuing processor may not couple to every card network (e.g., may omit or drop support for a card network), such that an interface to the issuing processor may become deprecated, and a new interface is generated (which, in turn, includes a different issuer entity suffering from the same portability issues as the first interface).

A card can be created or managed according to a card program. For example, a card program for a retailer can include one or more daily spend limits, restrictions according to any card or exchange (e.g., transaction) attribute, such as an MCC or geolocation (e.g., outside of the United States), or other features. Merely for ease of description, various features are referred to as program features which may be implemented across any number of accounts. For example, a card program associated with a retailer can implement various program features as indicated by the retailer, and may include a common daily spend limit MCC spend limit, geographical restriction, or the like. According to some implementations of the present disclosure, any of the program features may be implemented for an individual account without reference to a program, or cards associated with programs can have particular features adjusted. For example, the daily spend limit, described above, may be based on individual cardholder characteristics or adjusted responsive to user requests.

As used herein, a “card” can refer to or correspond to an account corresponding to one or more ledgers, or a physical or virtual token or identification method associated therewith. For example, a card can correspond to a physical credit, debit, or other stored value account. The card may correspond to a virtual card of a mobile wallet, or other stored value account. A card can refer to a token used according to a physical presence of a token (e.g., mobile wallet or credit card). A card can refer to another operative connection, such as a token (e.g., account number, virtual account number, or other information) provided via a wired or wireless network. A card can refer to a reference to pre-communicated information, such as an indication to process an exchange based on previously converted credentials (e.g., a saved payment card).

As used herein, “exchange management” can refer to managing exchanges associated with the various issuing processors. For example, exchange management can refer to processing authorization or pre-authorization requests (sometimes colloquially referred to as “swipes” but which can refer to various information provisions such as according to an NFC payment device, online credential conveyances, or so forth). Exchange management can refer to various other actions associated with a prior swipe such as exchange (e.g., transaction) reversals, settlement, cancelations, or so forth.

As used herein, an “issuer entity” is any data structure or combination thereof, associated with an issuer. For example, the issuer entity be or include a data object (e.g., file, relational database, strings, JSON objects, XML files, other documents, etc.), a data field, or a combination thereof. The issuer entity can be sourced, derived, or generated based on a code base or API (e.g., controls or rules) of an issuing processor, or a parameter (e.g., spending limits or account numbers), associated therewith. In some embodiments, the issuer entity for each issuing processor can be or include a separate API. The issuer entity can relate to card creation (e.g., issuance/instantiation), other card administrative functions, or to exchange management. For example, the issuer entity can relate to various card fields, such as fields which are associated with one or more card programs, such as to define one or more card features, limits, depictions, or other attribute(s). Such fields can be provided incident to generating a card (e.g., requesting card creation) or maintaining the card (e.g., adjusting or communicating the various card fields). The issuer entity can be associated with an issuer account, referring to an account associated with one or more cards associated with an issuing processor. For example, the issuing account can be accessible via credentials associated with the issuer entity.

As used herein, a “resource” is a component of computational functionality accessible to one or more component of the systems and methods disclosed herein. For example, a resource can include a hardware resource (e.g., circuit), a software resource (e.g., instructions or data mappings stored on a non-volatile memory), a data resource (e.g., information of a data repository). Some resources may further specify an attribute thereof, such as a shared resource (e.g., a resource accessible by two or more components), a network resource (e.g., a resource associated with networked components, such as bandwidth, IP address rages, or server loading), or a virtual resources (e.g., a resource implemented or scaled according to a demand therefor). For example, resources for instantiating, modifying, or managing a card can include various hardware circuits, instructions, or other information used to achieve such instantiation, modification, or management.

### A. Issuing Processor Aggregation System

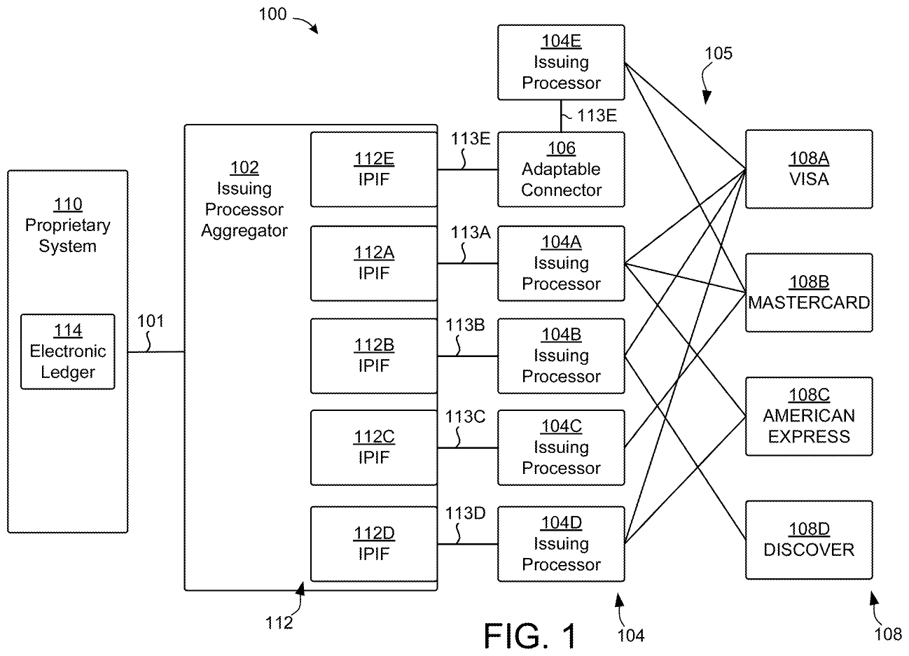

FIG. 1 is a block diagram of a system 100 including an issuing processor aggregator 102. The issuing processor aggregator 102 can aggregate interfaces to issuing processors 104. Issuing processors 104 can, in turn, implement connections to various card networks 108. For example, to implement a card program, information should be exchanged over a connection to an issuing processor 104. However, various issuing processors 104 can include computing systems which include differing data, differing data formats, or differing functions. Thus, it may be difficult for a system to interface between various issuing processors 104. For example, where different issuing processors 104 are connected to different networks, a computing system may interoperate with multiple issuing processors 104, or incident to a selection of a new issuing processor, a computing system may be migrated between issuing processors 104. However, once integrated with a first issuing processor 104, it may be difficult to migrate to another.

To overcome the aforementioned technical deficiencies, the issuing processor aggregator 102 can operate as middleware between a computing system and any number of issuing processors 104. For example, the issuing processor aggregator 102 can include various interfaces (e.g., issuing processor integration interfaces (IPIFs) 112, connections, etc.). The interfaces can be or can include API's, push or pull notification systems, data repositories accessible by an issuing processor 104, combinations thereof, or the like. The issuing processor aggregator 102 can communicate across the various interfaces by translating data into a format that matches an interface. Such translation can include generating or enriching data, translating information, or performing multiple operations for one issuing processor 104 to match a same functionality as another issuing processor 104, in a manner which is transparent to a computing device (e.g., at a uniform interface 101). For example, the issuing processor aggregator 102 can convert various data of an issuer entity to a uniform format (e.g., JSON) that can be used to update an electronic ledger 114 hosted on a remote computer system (e.g., the proprietary system). For example, the electronic ledger can include a nested data structure relating to cardholders, accounts, exchanges, and so forth.

The issuing processor aggregator 102 connects to a first issuing processor 104A, second issuing processor 104B, third issuing processor 104C, fourth issuing processor 104D, and fifth issuing processor 104E (collectively, issuing processors 104, also referred to as issuer processors 104, without limiting effect). The various issuing processors 104 can, in turn, connect to various networks referred to collectively as card networks 108. Particularly, the depicted system 100 includes the non-limiting illustrative examples of a VISA® network 108A, MasterCard® network 108B, American Express® network 108C, and Discover® network 108D. Each issuing processor 104 can connect to any number of card networks 108 over a respective connection 105 thereto. For example, as depicted, various issuing processors 104 may connect to at least one of the card networks 108 and/or may omit a connection to one or more card networks 108. A proprietary system 110, such as a merchant-related component of a POS device or a computer hosting an electronic ledger for the different issuing processors 104 can interface with one issuing processors 104, via the issuing processor aggregator 102, or can connect to more than one issuing processor 104 (e.g., to connect to an omitted network) or may not process exchanges associated with such networks.

An electronic ledger 114 is depicted as constituent to a proprietary system 110. According to various embodiments, the electronic ledger 114 can couple to various system 100 components. The various components of the proprietary system 110 (e.g., the electronic ledger 114) can be associated with a uniform interface 101. However, as indicated above, the various issuing processor connections 113, can vary from each other and from the uniform interface 101. Thus, various issuing processor integration interfaces (IPIF) 112 can intermediate a corresponding issuing processor 104 from the uniform interface 101. The IPIF 112 can adapt, translate, generate, supplement, enrich, or otherwise retrieve information from various sources to adapt an entity (e.g., one or more data structures) between the issuing processor 104 and the uniform interface 101. For example, the adaptation can include a translation for a uniform interface 101 associated with the electronic ledger 114 of FIG. 1.

The uniform interface 101 can include an application programming interface (API) which can be configured to receive data according to a pre-determined format. For example, the uniform interface 101 can arrange information according to JSON, XML, or other format. The issuing processor aggregator 102 can exchange information with the uniform interface 101 (e.g., receive from, or convey to). For example, the issuing processor aggregator 102 can retrieve data of an issuer entity from other connections including other APIs, FTP sites, or other repositories, push notification, emails, or other data conveyance paths and adapt said data to the uniform interface.

Each proprietary system (e.g., merchant) can instantiate a separate instance of the issuing processor aggregator 102, such that merchant information contained within the issuing processor aggregator 102 is segregated from other merchants. The depicted instance of the issuing processor aggregator 102 couples to the various issuing processors 104 via respective connections. For example, various connections shown as direction connections, such as a first connection 113A between the first issuing processor 104A and the first IPIF 112A can include a logically direct connection (e.g., an issuer entity portion conveyed by the first IPIF 112A can be the same as is received by the issuing processors 104). Such connections can include various intermediary devices such as switches, routers, cables, or so forth, which can include appendages or concatenations of various checksums, framing or packetizing padding or data, or so forth. As depicted, a second connection 113B between a second IPIF 112B and a second issuing processor 104B; third connection 113C between a third IPIF 112C and a third issuing processor 104C; or fourth connection 113D between a fourth IPIF 112D and a fourth issuing processor 104D can likewise interface without logical intermediation. The various IPIF 112A, 112B, 112C, 112D, 112E may be referred to, collectively, as IPIF 112.

According to the present disclosure, the issuing processor aggregator 102 can implement one or more interfaces to couple to any number of issuing processors. One or more interfaces generated by the issuing processor aggregator 102 can be configured to couple to an adaptable connector 106 to connect to the issuing processor 104. For example, the adaptable connector 106 can implement any of the translations (e.g., generations) discussed herein. That is, the adaptable connector 106 may be adaptable to a previously generated interface, and may further provide a connector for a uniform interface 101. For example, the adaptable connector 106 can implement a data enrichment operation, such as by comparing a predefined list of merchants to a location, MCC, or other issuer entity.

In some embodiments, the adaptable connector 106 can be or include an application operating on an external computing device from the issuing processor aggregator 102. The adaptable connector 106 can operate as middleware between the issuing processor aggregator 102 and the issuing processor 104E. In doing so, the adaptable connector 106 can transfer data between the issuing processor 104 and the issuing processor aggregator 102 (e.g., through the IPIF 112E), in some cases without any modification. Such can be advantageous, for example, when systems connect with the issuing processor aggregator 102 that already are connected to an issuing processor. Such systems can operate to route communication between the issuing processor aggregator 102 and the issuing processor to perform different functions, such as to complete exchanges.

As depicted, and in some embodiments, the adaptable connector 106 intermediates a fifth connection 113E between the fifth IPIF 112E and a fifth issuing processor 104E. The adaptable connector 106 can perform any of the operations of the various IPIF 112. For example, the adaptable connector 106 can perform a first portion of enrichment operations for translations between the various exchanges and the uniform interface 101, and the fifth IPIF 112E can perform any additional or further operations. For example, the issuing processor aggregator 102 can lack a connection 113 to directly interface with the fifth issuing processor 104E, and a merchant can include a pre-defined interface to couple to an issuing processor 104. The pre-defined interface can include various connectors to data enrichment tables, servers, or other data sources for an issuer entity such that including a connection to the adaptable connector 106 can provide a translator to the uniform interface with obviates at least some operations of architecting an IPIF 112E to couple directly to the fifth issuing processor 104E (e.g., defining or consolidating data sources to generate instances of the issuer entity which are mappable or translatable to the uniform interface).

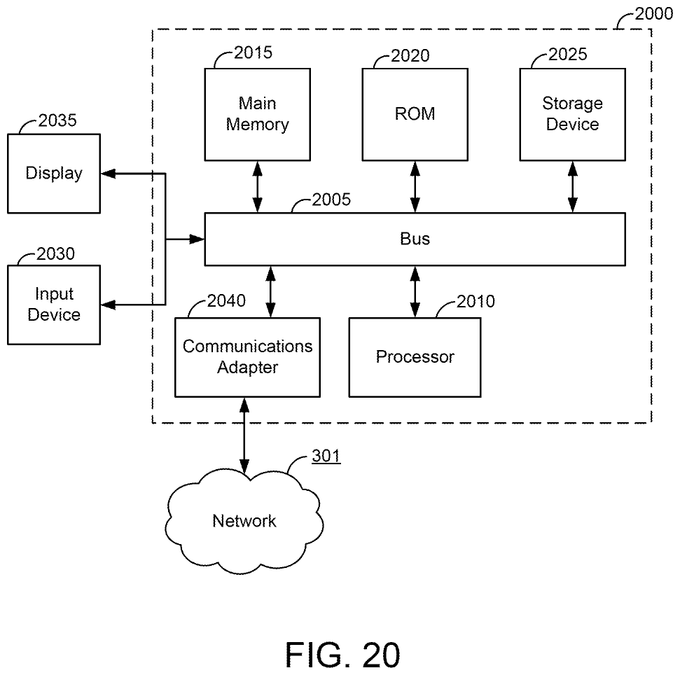

Each system or device in the computing environment may include one or more processors, memories, network interfaces (sometimes referred to herein as a “network circuit”) and user interfaces. The memory may store programming logic that, when executed by the processor, controls the operation of the corresponding computing system or device. The memory may also store data in databases. For example, the system 100, or the various components thereof can include one or more components or structures of functionality of computing devices depicted in FIG. 20. The network interfaces may allow the computing systems and devices to communicate wirelessly or otherwise, e.g., via a network. The various components of devices in the computing environment may be implemented via hardware (e.g., circuitry), software (e.g., executable code), or any combination thereof. Systems, devices, and components in FIG. 1 can be added, deleted, integrated, separated, and/or rearranged in various embodiments of the disclosure.

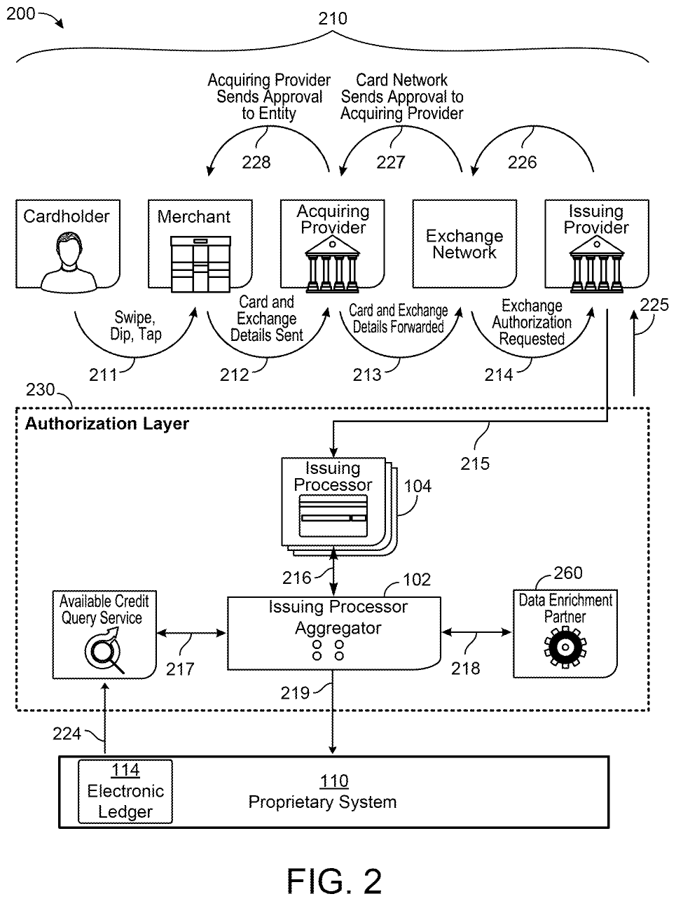

FIG. 2 is a system architecture 200 for aggregating issuing processors 104, according to some implementations. The system architecture 200 depicts the process of a cardholder performing an exchange and the components of an authorization layer 230 (in particular, issuing processors 104 and an issuing processor aggregator 102) receiving exchange data from a provider for processing the exchange. A computing environment 210 depicts the process of exchanging information between the cardholder, merchant, providers and card networks 108. For example, at 211 the user can perform a swipe action (e.g., dip, tap or otherwise provide card information to a merchant), such as by interfacing a physical card or mobile wallet with a point of sale (POS) terminal. At 212, the card and exchange details (or data) can be sent to an acquiring provider (e.g., acquiring financial institution (FI)). At 213, the acquiring provider can forward the card information (or other requital form) and exchange details to a card network 108, and at 214 the card network 108 can request, from an issuing provider, an exchange authorization (e.g., authorizing the exchange).

It will be understood that the description of the 215-225 described herein may be executed by an issuing processor aggregator 102 and devices connected thereto, in particular, issuing processors 104, a data enrichment source 260 and an authorization service. The authorization service can include at least a service to query an available credit, based on an electronic ledger 114 of the proprietary system 110. In general, the authorization layer 230 includes processing of the exchange after the exchange authorization is requested. The authorization can be performed by, for example, one or more components of the system of FIG. 1. At 215, the issuing provider can provide to the issuing processor 104, exchange data of an exchange. In some implementations, at 215, the issuing processor can query the issuing provider on a periodic basis for new changes. At 216, the exchange and exchange data can be encrypted and/or a secure communication channel (e.g., secure socket layer (SSL), transport layer security (TLS), etc.) can be established between the issuing provider and proprietary system 110. With continued reference to 216, an issuer entity (e.g., data fields, data structures, information disposed within computer-readable instructions, or other information associated with card creation, administrative functions, or exchange management) can be exchanged over a connection between the issuing processor 104 and the issuing processor aggregator 102. The issuer entity can be exchanged according to one or more messages over one or more communications channels, such as an encrypted channel, as provided above. The messages can be provided as point to point messages, or by a provision of any number of data fields of an issuer entity to a shared resource (e.g., a shared memory, a mutually accessible server location, or another data repository).

At 217, the exchange data can be cross-referenced with an available balance query service to determine an available balance associated with received card information. The service can base the available balance on an available balance of an electronic ledger 114 of a proprietary system 110, or on card data (e.g., program data) associated with a card. For example, an exchange exceeding an exchange limit, daily spend limit, MCC category limit, or located in a restricted area may be indicative of a non-approval, even where an available balance exceeds an exchange amount.

At 218, the exchange data can be augmented or enriched with additional data (or supplemental data) from a data enrichment source(s) (or partner) 260. The additional data may, for example, provide additional information about a merchant or other participant to an exchange. The additional information can enable additional searching, sorting, routing, etc. of an exchange according to additional features or attributes. Additionally or alternatively, at 218, the exchange data can be sent (e.g., securely) to the data enrichment source(s) 260 to scrub and/or clean (e.g., fixing incorrect, incomplete, duplicate or otherwise erroneous data in the data set, detecting and correcting corrupt or inaccurate records from a record set, table, or database and by incomplete, incorrect, inaccurate, or irrelevant parts of the data and then replacing, modifying, or deleting the dirty or coarse data). The data enrichment source 260 can be a component of the system, or may otherwise be connected thereto. For example, the data enrichment source(s) can be or include a look-up table hosted by a same computing device as other system components (e.g., the issuing processor aggregator 102), or a remote device operated by a third party partner.

At 219, the exchange can be posted or sent to the proprietary system 110. The proprietary system 110 can perform any number of operations based on the receipt of the exchange data, such as adjustment or appendage to the electronic ledger 114. For example, the proprietary system 110 can adjust an available balance, number of exchanges per day, exchange history, or other information. The proprietary system 110 can also generate, at 224, information associated with the exchange data, such as an indication that an exchange amount does not exceed an available balance, that a geolocation associated with the exchange is not restricted, or that an associated MCC is not restricted. Such indications can be provided according to an explicit indication or an indication of authorization or non-authorization. At 225, the issuing provider can be provided a response. The response can include an indication the exchange was successfully recorded (e.g., an approval) in a table. At 226, the issuing provider sends approval to a card network 108. At 227, the card network can send an approval to the acquiring provider. At 228, the acquiring provider can send the approval to the merchant.

The receipt of the approval, by the merchant, can be received prior to an expiration of a predefined time. For example, the merchant can include a timeout such that the merchant can locally reject an exchange upon the predefined time (e.g., five seconds) elapsing. Such a technique can improve operational security, such as to reduce a time used by a man-in-the-middle attack which may incur further delay. However, the various operations can include operations across a network which are not generally completed prior to the elapsing of the predefined time. For example, the issuing processor aggregator 102 can gather data from various data sources associated with an issuer entity and convey the issuer entity to the proprietary system over a uniform interface. The uniform interface can be configured to reduce a number of operations performed by the proprietary system 110, such as by providing the issuer entity according to a same data structure (e.g., an electronic data structure) as the electronic ledger. That is, the conveyance of information at 219 can include a conveyance of information over a uniform interface. Such a retrieval of disaggregated system and provision of data corresponding to the electronic ledger 114 of the proprietary system 110 can reduce latency of communication, such that the exchange can process prior to an expiration of the exchange at the merchant POS.

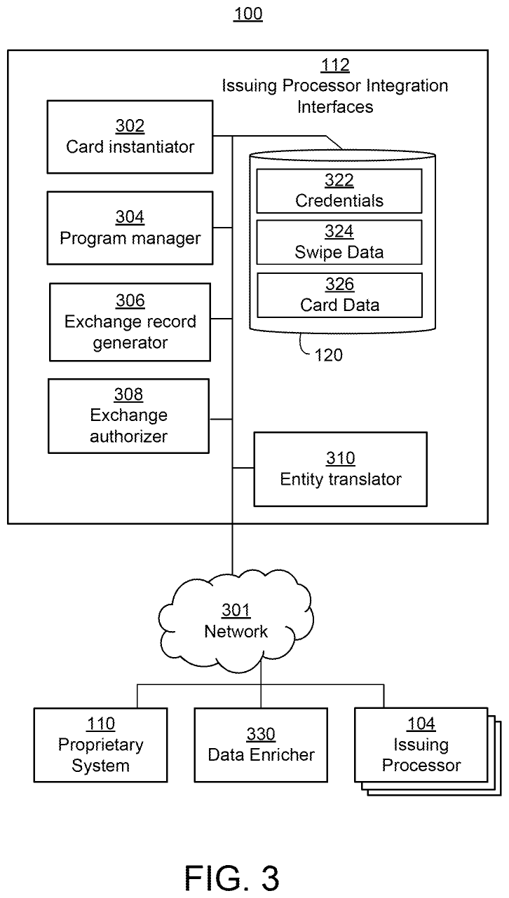

FIG. 3 is a block diagram of an issuing processor aggregator interface (IPIF) 112 of an issuing processor aggregator 102, according to some implementations. The IPIF 112 can include or interface with at least one card instantiator 302. The IPIF 112 can include or interface with at least one program manager 304. The IPIF 112 can include or interface with at least one exchange record generator 306. The IPIF 112 can include or interface with at least one exchange authorizer 308. The IPIF 112 can include or interface with at least one entity translator 310. The card instantiator 302, program manager 304, exchange record generator 306, exchange authorizer 308, or entity translator 310 can each include at least one processing unit or other logic device such as programmable logic array engine, or module configured to communicate with a data repository 320 or database. The card instantiator 302, program manager 304, exchange record generator 306, exchange authorizer 308, or entity translator 310 can be separate components, a single component, or part of the issuing processor aggregator 102, and can include or interface with, or be components of, the system 100 of FIG. 1. The IPIF 112 or can include hardware elements, such as one or more processors, logic devices, or circuits. For example, the IPIF 112, like other components of the system 100 of FIG. 1, can include one or more components or structures of functionality of computing devices depicted in FIG. 20.

The various components of the IPIF 112 can be in network communication via a Peripheral Component Interconnect Express (PCIe) network 301, Ethernet network 301, wireless fidelity (Wi-Fi) network 301, combinations thereof, or the like, including any number of other wired or wireless networks 301. Moreover, the network 301 can interface with various other components such as a cloud based portion of a data repository 320. The network 301 can include computer networks such as the Internet, local, wide, metro, or other area networks, intranets, cellular networks, satellite networks, and other communication networks such as Bluetooth, or data mobile telephone networks. The network 301 can be public or private. The various elements of the system 100 can communicate over the network 301.

The data repository 320 can include one or more local or distributed databases, and can include a database management system. For example, the data repository 320 can include credentials 322, swipe data 324, or card data 326 (e.g., card records).

A credential 322 may refer to or include a token, user name/password combination, or other indication of authentication or authorization. For example, the credentials 322 can be associated with a card program corresponding to one or more cards, wherein a representation of an electronic ledger 114 or information associated therewith (e.g., any other information of the data repository 320 or otherwise accessible to the issuing processor aggregator 102). Credentials can vary according to an access. For example, a cardholder credential can be provided to cause a display of a card associated with the cardholder. A program credential can be provided to cause a display of card data 326 associated with any cards associated with a program.

Swipe data 324 can refer to or include information provided incident to an exchange (e.g., a transaction). For example, the swipe data 324 can include an account number, account holder, merchant identifier, merchant category code (MCC), exchange amount or authorization type (e.g., authorization, pre-authorization, adjustment, release, etc.). The swipe data can include an indication of card presence or absence (e.g., an online or in-person order). The swipe data 324 can include information received from a merchant or information received from another source. For example, the swipe data can include a first data structure originating at a merchant POS, based on an interaction with a mobile wallet, and second information from the mobile wallet (e.g., a location, authentication type, token, or so forth). The swipe data 324 can further include subsequent data structures related to an initial provision of card information. For example, further information can include a cancelation, a release of a hold, or an adjustment (e.g., indication of a tip, or an exchange which is for a different amount that an initial authorization, as in the case of a fuel purchase).

The swipe data 324 can include the data structure received from a device proximal to the exchange (e.g., the POS or mobile wallet) or other data structures or fields substituted for, modified by, or appended to such data structures, such as data fields provided by the acquiring provider, card other exchange network, issuing provider, or issuing processors. For example, various identifiers, risks, timestamps, etc., may be referred to as swipe data, when associated with a card swipe action.

Card data 326 (also referred to as card information, without limiting effect) may refer to or include information assisted with a card. For example, the card data 326 can include any information associated with a cardholder, which may be referred to as a card holder field (e.g., home address, billing address, unique identifier, personal identification number). The card data 326 may refer to or include information associated with an account. For example, the account can include account credentials, numbers, cycle information, ledgers (e.g., a balance of a stored value card, available credit of a credit card, a cash advance value, etc.). The account information can include limits associated with a daily spend, daily withdrawal, MCC spend, number of exchanges per time period, or the like.

In some embodiments, the card data 326 can be defined according to a card program. For example, all cards associated with a merchant, organization, bank, or other card program can include one or more data fields defined according to the program. For example, a card program for an association of homebuilders may be associated with no daily spend limit at a construction related MCC. Another card program for cardholders building credit may be associated with a daily spend limit. The association between a data field and a card program can be persistent or a default. For example, in some embodiments, the data field based on the program can be edited according to a request. For example, a cardholder of a card associated with a geographical restriction can request a temporary or permanent removal of the restriction incident to planned travel. The card data 326 may be stored in a nested data structure, such as nested account corresponding to one or more accounts of a user, each account corresponding to one or more exchanges. The data structure can be or be similar to a data structure of the electronic ledger 114 of the proprietary system 110. For example, the card data 326 or other data of the data repository 120 can be duplicative of data stored at the proprietary system 110, can be received therefrom, or can reside thereon.

Card data 326 can include card attributes, which can refer to attributes of a card associated with a nested data structure of an electronic ledger 114. A card attribute can include information received from or provided to the electronic ledger 114. For example, a card creation request can include card attributes such as a requested BIN range, cardholder name, cardholder address, card type, card status, credit limit, or cardholder agreement terms. Upon card creation, further card attributes may be associated with the card such as a card number, card verification code (CVC), expiration date, cardholder rewards, etc.

The card instantiator 302 can cause cards to be generated. The card instantiator can receive an indication of a cardholder for the card, such as a name, identifier, or linkage to a user included in an existing data structure. In some instances, (e.g., a new cardholder), the card instantiator 302 can receive card holder fields to generate a new entry for the cardholder. The cardholder fields can be compared to one or more existing cardholders. For example, the card instantiator 302 can determine a merger or two cardholders based on a same address, unique identifier (e.g., social security number, phone number, or email address). The card instantiator 302 can determine that card holder fields do not correspond to an existing cardholder, and generate a new entry for a cardholder based on the determination.

The card instantiator 302 can identify one or more data fields of a uniform interface 101 associated with a cardholder. The card instantiator 302 can provide one or more cardholder fields to the entity translator 310. For example, the card instantiator 302 can provide cardholder fields including a cellular telephone, work telephone, or home telephone field. The entity translator 310 can return a value of a primary phone and secondary phone, or daytime phone and evening phone. The card instantiator 302 can provide one or more data fields to a data enricher 330 of, or interfacing with the system of FIG. 1 (e.g., the data enrichment source 260 depicted in FIG. 2). For example, the card instantiator 302 can provide an address to the data enricher 330, and receive an enriched address. The enriched address can include further fields, such as to a ZIP+4 code generated from address, can include changes to an address, such as to correct “123 Main Av.” to “123 MAIN AVE” according to a desired format. The enriched address can generate a street address based on other location information, such as a latitude and longitude, or otherwise enrich received information.

The enriched card holder fields can correspond to one or more interfaces, such as a uniform interface 101 or one or more issuing processor connections 113. For example, the phone fields, discussed above, can be received as cellular telephone, work telephone, home telephone and home telephone fields. The uniform interface 101 can include primary phone and secondary phone fields, and the issuing processor connection 113 can include a daytime phone and evening phone field. The IPIF 112 can map one or more fields between the respective interfaces. Such mapping can be dynamic or static. For example, the IPIF 112 can receive an indication of a time, compare the time to a predefined threshold, and determine, based on the time, whether the daytime phone should map to a primary or secondary number. Thusly, the card instantiator 302 can generate data fields corresponding to one or more interfaces. Thus, information received can be configured for provision to the uniform interface 101 or the various issuing processor connections 113.

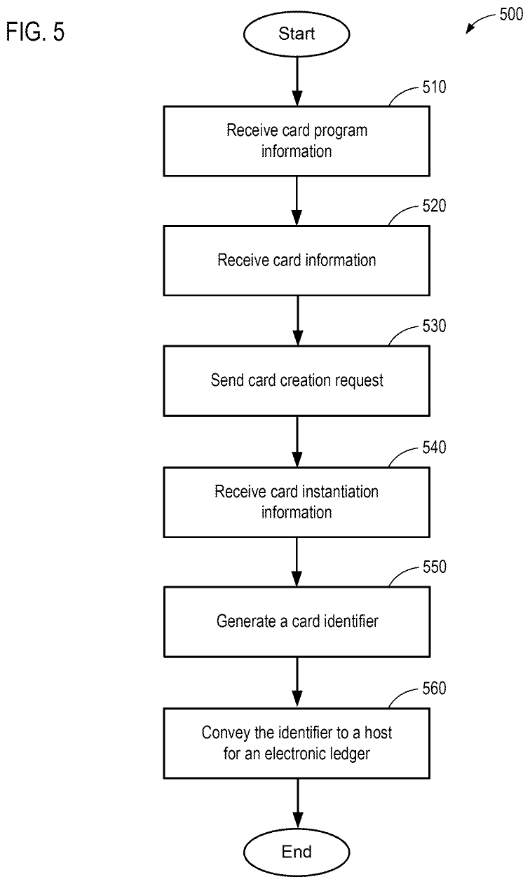

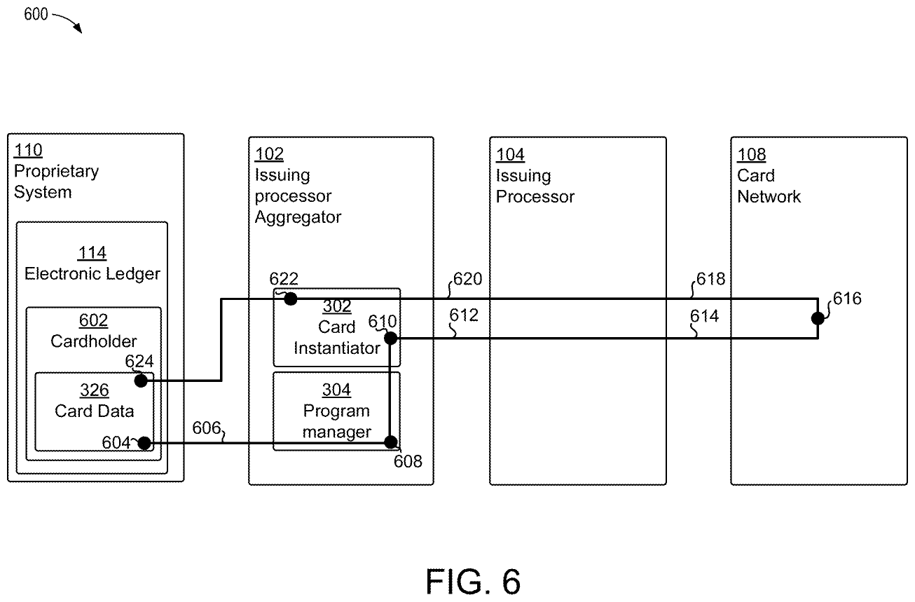

The card instantiator 302 can receive information associated with the card from the proprietary system 110, the information corresponding to the uniform interface, and provide the information to the issuing processor 104 in accordance with an issuing processor connection 113 (e.g., a card creation request). The card instantiator 302 can receive card information from the issuing provider responsive to the card creation request. The card instantiator 302 can provide further information to the proprietary system 110 responsive to the receipt of the card information. Example flows are provided hereinafter, at FIGS. 5 and 6.

The card instantiator 302 can receive a selection of a card program for one or more cards. For example, the selection of the card program can correspond to one or more predefined data fields associated with an account. The card instantiator 302 can include or interface with card data 326 associated with the program. For example, the card instantiator 302 can interface with card data 326 of the data repository 320, or with the program manager 304 to associate a card program with a card. In some instances, card data 326 can be specific to a card. That is, the card program can be a card-specific card program. References, herein, to program data can refer to either programs associated with one card, many cards, or zero cards (e.g., programs which are generated prior to a first card creation). In some embodiments, the card program can correlate to a particular issuing processor 104.

The program manager 304 can manage a card program associated with any number of cards or cardholders. For example, the program manager 304 can receive one more data fields associated with a card program. The program manager 304 can adjust one or more data fields associated with a program or with an account. For example, some data fields can retain a setting corresponding to a card program at a time of creation. For example, a card program can correspond to a bank identification number (BIN) range associated therewith, wherein a change to a BIN or a program may not change a BIN of issued cards. In some instances or implementations, a data field associated with a card field can change, such as to replace all or some existing accounts (e.g., a change to a geographic or MCC restriction can propagate to some legacy accounts which do not include the restriction, but may not propagate to other legacy accounts which include a geographic or MCC restriction exception).

In some instances or implementations, the program manager 304 can manage data fields associated with a physical card, or a depiction of a virtual card. The data fields, or other information or communications associated with the program can be referred to collectively, as a program entity. For example, a card program associated with an athletic franchise, retailer, or credit union can include an associated color, logo, or other card design. The program manager 304 can store a record of a card design corresponding to a program for one or more cards, and provide such a design to one or more user interfaces, such that a user of the user interface can verify a card identity. For example, a presentation of a physical depiction of a card can aid a cardholder in ensuring a selection of an intended card, relative to a presentation of a last 4 account digits, issuing provider, or other card data which may be less familiar to some users.

The exchange record generator 306 can generate an exchange record (e.g., a file, document, table, listing, message, notification, etc.) responsive to a swipe action. For example, upon a receipt of swipe data 324 or other exchange data (e.g., operation 215 of FIG. 2), the exchange record generator 306 can parse the exchange data for one or more predefined fields (e.g., an exchange amount, exchange time, or category code such as an MCC). The exchange record generator 306 can generate an exchange record based on the parsed data. The exchange record can include one or more fields corresponding to the uniform interface 101. For example, the exchange record can include an authorization or exchange amount configured for provision to the proprietary system 110.

The exchange record generator 306 can maintain exchange records based on a receipt of additional swipe data. For example, the exchange record generator 306 can append or substitute exchange record data fields, as in the case of an exchange processing subsequent to a hold, or an adjustment, credit, cancellation, or other action subsequent to a generation of an exchange record. The exchange record generator 306 can generate any portion of the exchange record for provision to another device over the uniform interface 101, or one of the issuing processor connections 113. For example, the exchange record generator 306 can interface with the entity translator 310 to generate multiple (e.g., duplicative) data fields corresponding to a same element parsed from the exchange data. Such duplicative data fields may reduce latency of communication with one or more interfaces. The exchange record generator 306 can interface with the entity translator 310 to generate translations incident to provision or receipt of various messages, which may reduce memory used by the exchange record generator 306, according to some embodiments.

The exchange record generator 306 can append or provide authorization information to an exchange record, such as to record an authorization approval, denial, reason code, or other information. The exchange record generator 306 can append or provide settlement information associated with clearing an exchange. For example, the exchange record generator 306 can interface with the exchange authorizer 308 to provide various exchange record authorization or settlement data.

The exchange record generator 306 can receive a dispute resolution entity such as one or more fields including information associated with a cardholder dispute of an exchange. Wherein some issuer entities of the various IPIF 112 include predefined fields associated with a dispute, the exchange record generator 306 can automatically adjust ledger information based on one or more fields of a dispute resolution entity. For example, a temporary adjustment to a balance, cancelation of a card, or other action can be performed. The exchange record generator 306 can append an exchange record information associated with a dispute, wherein the entity translator 310 can propagate data fields according to various formats, such as APIs, notifications, emails, data stored at a shared resource, etc. responsive to a receipt of the dispute resolution entity. For example, the propagation can be based on an identity of the issuing processor and the data field, as received across the uniform interface 101 from the proprietary system 110.

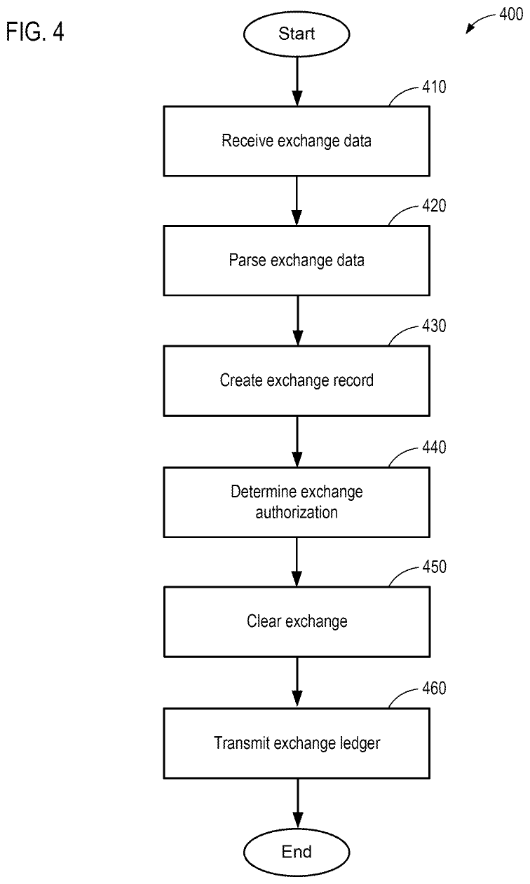

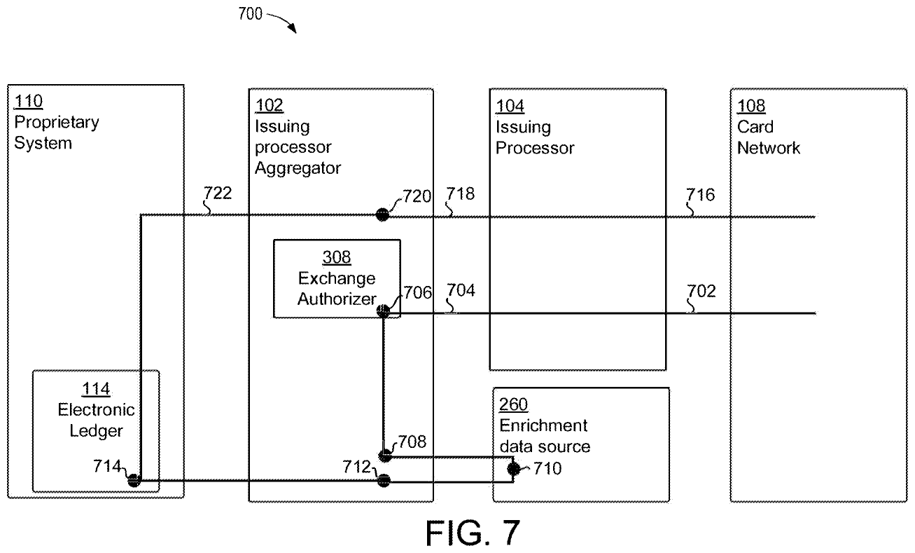

The exchange authorizer 308 can determine an authorization for an exchange. For example, the exchange authorizer 308 can interface with the proprietary system 110 (e.g., an electronic ledger 114 thereof, to determine an account balance) and an issuing processor 104 to authorize and clear an exchange. An example of exchange authorization is provided, hereinafter, with regard to FIG. 4 and FIG. 7.

The entity translator 310 can translate data fields associated with an issuer entity between a first instance configured for operation with the uniform interface 101 and one or more further instances configured for operation with respective issuing processor connections 113 of the system 100. For example, the various issuing processors 104 can include one or more different fields corresponding to a predefined translation.

Some translations can include predefined translations between differently formatted, organized, arranged, or other data fields. The data fields can be data fields of a data structure such as a relational database, or derived from computer-readable instructions (e.g., a constant, configuration setting, or relationship therebetween included in program code). Either of the data structure or instructions may be or a constituent to an issuer entity. The translation can concatenate, truncate, omit, or otherwise translate one or more data fields between interfaces. For example, an issuing processor connection 113 or uniform interface 101 can store a phone number according to a country code, or according to a phone type (e.g., cellular phone or home phone). Another interface can include flag bits for whether a phone can accept text messages, or whether a mobile wallet instance is hosted by the phone. The entity translator 310 can translate between the fields, which can include accessing further data sources (e.g., an indication of whether a particular phone hosts a mobile wallet can be stored at another location in a relational database, in another data structure, etc.).

The entity translator 310 can store one or more of the data fields according to a local data structure (e.g., a local cache), or convey any information between any connected interface. The entity translator 310 can further include or store outputs or inputs of the various translation operations. For example, one translation can include casting a string data type to an integer data type. Another translation can include comparing a first data field to a predefined value, and defining a second data field based on the value (e.g., the telephone number stored in a data field based on a bit flag value).

In some instances, translations may be dynamic, such as translations based on time of day, geographic location, or so forth. For example, a data field can correspond to a location of a user, a distance to a merchant, a geographic location or municipality such as a city, state, or country. A translation can depend upon available data and vary over time. For example, a card present bit can be determined according to swipe data 324 (e.g., a physical presence of a card), a coextensive location of a mobile device associated with a mobile wallet, and a merchant location associated with an exchange, or other data. A card present indication at one interface can include a bit flag indication, wherein a card present bit at another interface can include an indication of a source of the card present bit (e.g., may distinguish between a physical card presence such as an contactless “tap” card swipe, an insertion of a chip, a presence of a mobile wallet at a location associated with an exchange, or another verification method, such as a secondary online verification to establish a card present classification). The entity translator 310 can translate the card present indication according to a current or historical location of a user. For example, wherein a mobile device includes location data, or a cardholder provides swipe data 324 at a further merchant prior or subsequent to an exchange of interest, the entity translator 310 can determine a presence of a cardholder at the exchange of interest according to such location data (e.g., a card used at a merchant fifty miles from another exchange within five minutes, or from a mobile device of the user may not be indicative of a presence of the cardholder or card associated with the exchange of interest).

The entity translator 310 can interface with any number of data enrichment sources 260 to correct, modify, generate, or enhance data. A data enrichment source 260 can maintain merchant, cardholder, or other information. For example, the data enrichment source 260 can include a street address corresponding to a vendor location, or a vendor name (e.g., a vendor identifier of 987654-WMT S SLC UT 12345, can correspond to “Walmart store #12345, 123 Main Street, Salt Lake City Utah, 84415-1234). The entity translator 310 can identify information which does not correspond to a connected device or system (e.g., to one or more predefined formats for the uniform interface 101 or one or more of the issuing processor connections 113). For example, the entity translator 310 can determine a deviation between a data field and a data field associated with the uniform interface 101 or the connections 113. In response to the deviation, the entity translator 310 can provide the one or more data fields, information parsed therefrom, or another indication of data enrichment information (e.g., some data enrichment sources 260 can be configured to receive a numeric identifier for a unique merchant, such as 987654, some data enrichment sources 260 can be configured to receive a partial address, such as WMT S SLC UT, in combination with geographic data associated therewith, etc.). The entity translator 310 can receive a response from the data enrichment source 260 and update a data field with the enriched data. For example, the enriched data can correspond to a nested data structure of the electronic ledger 114 of the proprietary system.

The entity translator 310 can translate issuer entities according to a supported function of one or more issuing processors 104. For example, one issuing processor 104 can include a 7 day hold and a 30 day hold for exchange funds, wherein another issuing processor 104 may include only the 30 day hold. The entity translator 310 can issue a 30 day hold with the other issuing processor, and release the hold after 7 days to effect a 7 day hold. The entity translator 310 can provide, to the uniform interface 101, a same field associated with the explicit 7 day hold, or the 30 day hold which will be released after 7 days have elapsed. In another example, one issuing processor 104 can support incremental authorizations and another may not. The entity translator 310 can effect an incremental authorization by placing a hold, and thereafter releasing the hold and approving a separate exchange. For example, such information may be stored according to a nested data structure of the electronic ledger 114 of the proprietary system 110, such that the proprietary system 110 may interfere with the various issuing processors 104, as intermediated by the issuing processor aggregator 102, without generating separate fields for the various issuing processors 104.

Any of the translations of the entity translator 310 can be configured to translate between any of the issuing processor connections 113 and the uniform interface 101. Thus, the issuing processor aggregator 102 can present a single interface to any device connected thereto, along with the uniform interface 101 of the proprietary system 110. For example, any data enrichment sources 260 or other connections to the issuing processor aggregator 102 can be provided regardless of a selected or active IPIF 112, such that enrichment data may be available to more than one of the selected IPIF 112. For example, upon a change of a selection of an issuing processor 104, the connections to a data enrichment source 260 can be maintained, wherein any information can be translated, by the entity translator 310. The change of selection of the issuing processor 104 can be on an exchange basis, such as in response to receiving a card network 108 that is not supported by an issuing processor 104, or based on a replacement of one issuing processor 104 with another.

FIG. 4 is a flowchart of a method 400 to manage exchanges, according to some implementations. The method 400 can be performed by one or more processing circuits of one or more devices of FIG. 1. For example, the processing circuits can be or include processing circuits of the issuing processor aggregator 102. In broad overview of the method 400, at block 410, the one or more processing circuits can receive exchange data. At block 420, the one or more processing circuits can parse the exchange data. At block 430, the one or more processing circuits can create an exchange record. At block 440, the one or more processing circuits can determine an exchange authorization. At block 450, the one or more processing circuits can clear an exchange, based on the determination of the authorization. At block 460, the one or more processing circuits can transmit the exchange record for ledger recordation. Additional, fewer or different operations may be performed depending on the particular arrangement. In some embodiments, some, or all operations of the method 400 may be performed by one or more processors executing on one or more computing devices, systems or servers. In various embodiments, each operation may be re-ordered, added, removed or repeated.

Referring again to block 410, the one or more processing circuits can receive exchange data. The exchange data can include exchange data corresponding to an initial swipe action, or modifications, appendages, or other additions thereto. For example, the swipe data 324 can be provided by a physical or virtual card at a point of sale. The point of sale can include a POS terminal physically located at a merchant (e.g., as in the case of a tap to pay, physical swipe, chip insertion). The point of sale can include a virtual POS device (sometimes referred to as an eCommerce POS or Online POS). The swipe data can include an account number or other identifier (or portion thereof). For example, the swipe data can include a BIN which may be indicative of an issuing processor 104, a card program, or other aspects of card data 326.

The one or more processing circuits can receive exchange data for any number of exchanges. One or more received messages can correspond to each exchange, such as an initial swipe and any number of subsequent messages associated with the swipe (e.g., cancelations, adjustments, or the like). Each exchange can relate to a separate exchange associated with one or more merchants. The exchange data can include information from the merchant POS or from any other device in network communication therewith (e.g., operations 211, 212, 213, 214, or 215 of FIG. 2).

Referring again to block 420, the one or more processing circuits can parse, from the exchange data, a set of exchange data for each exchange. For example, the exchange data can include an amount of an exchange (e.g., a transaction amount, approval amount, hold amount, or other amount), an exchange time, a category code (e.g., MCC), or any other information associated with an exchange (e.g., a card present indicator, a transaction type, a geographic location, or so forth). The parsing can be according to a predefined format or data location in an issuer entity (e.g., of a comma separated list, a relational database, or another data structure). The parsing can be according to a content of the data. For example, the entity translator 310 can determine a predetermined data item corresponding to a data type (e.g., of a phone number account number, name, or so forth). Indeed, the entity translator 310 can parse any portion of the exchange data to translate information disposed therein according to the various translation operations as described with regard to, for example, FIG. 3. For example, the entity translator 310 can generate exchange data configured for interoperation with the uniform interface 101 or various further interfaces, such as any of the issuing processor connections 113.

Referring again to block 430, the one or more processing circuits can create an exchange record according to the exchange data. The exchange record can include the parsed information, along with any number of translations thereof. The exchange record can include one or more instances of the data record items. The instances can be configured to interface with one or more interfacing components, such as the proprietary system 110 (e.g., an electronic ledger 114 thereof) via the uniform interface 101 or any of the issuing processors 104 via a connection 113 thereto.

Referring again to block 440, the one or more processing circuits can determine authorization of the exchange. For example, the determination of the authorization can include determining the authorization according to at least an available balance of an account maintained in an electronic ledger 114. The authorization can be determined, by the exchange authorizer 308, for example, such as according to locally cached or stored instance of authorization data, or via messages conveyed, across the uniform interface 101, to the proprietary system (e.g., an available balance of an account maintained in the electronic ledger 114).

Referring again to block 450, the one or more processing circuits can clear an exchange record. The exchange record can be cleared responsive to an authorization output, such as an authorization approval or a message with another authorization response (e.g., for an incremental approval). The exchange record can be batched with zero or more additional exchange records to form an exchange record batch (e.g., zero or more approved exchanges). The issuing processor aggregator 102 can provide the batched exchange records according to a predefined time (e.g., hourly, daily, or so forth). The issuing processor aggregator 102 can pass the batched exchange records via an issuing processor connection 113 to an issuing processor 104 (including any adjustments between batches of the various interfaces, such as by generating null messages or casting periodic messages as notifications). The issuing processor 104 may, in turn, provide the batched exchange records to an issuing provider, card network 108, acquiring provider, or merchant.

Referring again to block 460, the one or more processing circuits can transmit the exchange record for ledger recordation. For example, the exchange records may be provided as uniform to the plurality of issuing processor integration interfaces. For example, the exchange record (or a batch thereof), can be configured for provision to any of the IPIF 112, or the uniform interface 101 for ledger recordation. The ledger can include an electronic ledger 114 of the proprietary system 110 or various further ledgers which may be maintained, provided, or interfaced with the various further system architecture 200 components depicted in FIG. 2 (e.g., a merchant, acquiring provider, card network 108, or issuing provider, or issuing processor ledger).

FIG. 5 is a flowchart of a method 500 to generate or instantiate a card, according to some implementations. The method 500 can be performed by one or more processing circuits of one or more devices of FIG. 1. For example, the processing circuits can be or include processing circuits of the issuing processor aggregator 102. Further, any computing device described herein can be configured to perform method 500. In general, in broad overview of method 500, at block 510, the one or more processing circuits can receive card program information. At block 520, the one or more processing circuits can receive card information. At block 530, the one or more processing circuits can send a card creation request. At block 540, the one or more processing circuits can receive card instantiation information. At block 550, the one or more processing circuits can generate a card identifier. At block 560, the one or more processing circuits can convey the identifier to a host for an electronic ledger 114. Additional, fewer or different operations may be performed depending on the particular arrangement. In some embodiments, some, or all operations of the method 500 may be performed by one or more processors executing on one or more computing devices, systems or servers. In various embodiments, each operation may be re-ordered, added, removed or repeated.

Referring again to block 510, the one or more processing circuits can receive card program information. The card program information can include one or more predefined card data 326 fields. For example, the program can include a daily spend limit, MCC restriction, card design (e.g., logo or color), or other information. The card program information can include an indication of a change to an account, such as a change to data associated with a pre-existing cardholder, a pre-existing account, or the like, which may vary from information for new cards. For example, card program information can include a selection of an arbitration provision for new cards which is different than for existing cardholders or existing cards (e.g., to maintain an opt-in or opt-out of a cardholder).

Referring again to block 520, the one or more processing circuits can receive card information (also referred to as card data 326) for a new card. The card information can be received across one or more interfaces. For example, the card information can be received from a proprietary system 110, across a uniform interface 101, or at an issuing processor aggregator 102. Wherein the issuing processor aggregator 102 includes various IPIFs 112, the card information may be received at one of the various IPIFs 112. The card information can include one or more cardholder fields, and a selection of a card program associated with one or more cards. For example, the selection can be received at a program manager 304, such that the program manager 304 can select further fields corresponding to the program, according to program information received at block 510. The card program can correspond to an issuing processor 104 operatively coupled to the issuing processor aggregator 102 (via an IPIF 112). For example, a BIN can correspond to a card program and an issuing processor 104.

Referring again to block 530, the one or more processing circuits can send a card creation request. For example, the card creation request can be configured to interface with an IPIF 112 corresponding to an issuing processor 104 or provider. The create card request can include card information such as card attributes.

Referring again to block 540, the one or more processing circuits can receive an indication of further card attributes. For example, the further card attributes can include a status of the card (e.g., approved, issued, or activated). The status of the card may be further updated according to future issuer entity information, such as an indication of a blocked or canceled card subsequent to an issuance thereof. In some instances, a response can include an indication of a delay in issuance, such as a provision of a pending or review status.

Referring again to block 550, the one or more processing circuits can generate a unique identifier for the card. For example, the unique identifier can be based on an account or other number of the card, or an index value of a relational database or other data structure. For example, a unique identifier can be based on a cardholder in combination with a number of cards. For example, a second card of a cardholder can be provided as cardholder-2; a third card of a cardholder can be provided as cardholder-3, and so forth. In some instances, the unique identifier can be separate from an account number, such that communications referring to the account number may omit the account number, which may reduce transmission packet size, increasing throughput or maintain account security.

Referring again to block 560, the one or more processing circuits can convey the unique identifier to a host for an electronic ledger 114 associated with the card. For example, the issuing processor aggregator 102 can convey the unique identifier to the proprietary system for inclusion in the electronic ledger 114. As indicated above, at block 550, the unique identifier can be generated based on a nested data structure of the electronic ledger 114, such that the provision, across the uniform interface 101 can be according to the nested structure.

FIG. 6 is a flow diagram 600 depicting card generation, according to some implementations. The flow diagram 600 can correspond to a flow of the method 500 of FIG. 5, wherein the one or more processing circuits are or include processing circuits of the issuing processor aggregator 102. For example, the issuing processor aggregator 102 can include an IPIF 112 connected to the issuing processor 104 via an issuing processor connection 113. The operations and messages described herein can be re-ordered, modified, adjusted, omitted, or further operations or messages can be included. Moreover, some messages or operations described herein in the singular can refer to multiple messages or operations, such as iterative or sequential operations or messages.

A proprietary system 110 can include an electronic ledger 114. The electronic ledger 114 can be a component of or include a nested data structure further including any number of cardholders and card data 326 for one or more cards of the cardholder 602. At operation 604, the proprietary system 110 can receive or gather card creation data. The proprietary system 110 can associate a portion of the electronic ledger 114 with the card creation data, such as a line of credit or stored value card program. The card program can include any number of predefined data fields. At operation 606, the card creation request is conveyed, over the uniform interface 101, to an issuing processor aggregator 102.

At operation 608, the card creation request is received by the program manager 304. The issuing processor aggregator 102 can save the card creation request in a card entity table. For example, the table can include a first portion of data corresponding to card creation data such as card attributes defined by the proprietary system 110 or the issuing processor aggregator 102.

At operation 610, the card instantiator 302 provides a card creation request according to a particular IPIF 112 associated with the issuing processor 104 for the card. For example, the card instantiator 302 can generate various messages (not depicted) for communication with the entity translator or the data enricher to generate data formatted for provision to the issuing processor 104. The card creation request is thereafter sent to the issuing processor 104 via message 612. Responsive to the receipt of message 612, the issuing processor can generate a further message 614 for provision to a card network 108. In various implementations, various further messages may be generated, such as messages for or corresponding to an issuer provider associated with the card. According to the depicted implementation, at operation 616, the card network 108 generates a card (e.g., a digital representation, instance, or other data structure corresponding to the card). The card generation can include various card data 326 such as card attributes to be conveyed to the proprietary system 110 or issuing processor 104 for storage. For example, the card network 108 can generate an account number, token, expiration data, card verification code or other card attribute for storage or conveyance.

The card network 108 can generate a message 618 for the issuing processor 104; the message 618 can cause the issuing processor 104 to generate a further message for the issuing processor aggregator 102. Messages 618 and 620 (like messages 612 and 614) can include different information. For example, the issuing processor aggregator 102, issuing processor 104, card or card network 108 can append additional fields to a message, remove data from a field, substitute information, or translate various data fields of a data entity. Thus, at operation 622, wherein the issuing processor aggregator 102 receives card data 326, the card instantiator 302 can update the card entity table of operation 610. That is, the card instantiator 302 can substitute preliminary fields, or changes (e.g., a change from an expected expiration date), or can complete omitted fields (e.g., an account number, CVC, or other card attributes). Any portions of such a card entity table, translations thereof, or the like can be conveyed to the proprietary system 110 for recordation in the electronic ledger 114 at operation 624. For example, the recordation can generate a link between the card entity table and the electronic ledger 114, such that exchange data associated with the card can be exchanged over a uniform interface 101 between the proprietary system 110 and the issuing processor aggregator 102 (e.g., as is described, henceforth, with regard to FIG. 7).

FIG. 7 is a flow diagram 700 depicting exchange management, according to some implementations. The flow diagram 700 can correspond to a flow of the method 400 of FIG. 4, wherein the one or more processing circuits are or include processing circuits of the issuing processor aggregator 102. For example, the issuing processor aggregator 102 can include an IPIF 112 connected to the issuing processor 104 via an issuing processor connection 113. The operations and messages described herein can be re-ordered, modified, adjusted, omitted, or further operations or messages can be included. Moreover, some messages or operations described herein in the singular can refer to multiple messages or operations, such as iterative or sequential operations or messages.

At operation 702, the card network 108 provides an indication of a swipe action to the issuing processor 104. For example, the card network 108 can receive swipe data 324 corresponding to the swipe action from a merchant, via one or more intermediaries, such as an acquiring provider. Responsive to the receipt of the message from the card network 108, the issuing processor 104 can provide a message 704 to the issuing processor aggregator 102. At operation 706, the exchange authorizer 308 can approve or deny the corresponding exchange based on one or more exchange (e.g., transaction) rules (e.g., a comparison of an exchange amount to a stored value or an available credit associated with a card). The authorization may not be an only or final approval. For example, the issuing processor 104 can generate a first determination of authorization (e.g., an authorization, non-authorization, pre-authorization, or other operation). Further, the exchange authorizer 308 can approve or deny the exchange based on one or more messages (not depicted) with the proprietary system 110. For example, the comparison to a balance can be based on a balance maintained in the electronic ledger 114, or otherwise maintained by the proprietary system 110.

At operation 708, the issuing processor aggregator 102 can generate an exchange record associated with the exchange. For example, the exchange record can include an indication of authorization, non-authorization, or a further reason code associated with the authorization. In some instances, the exchange record can be used to generate enriched exchange record data (e.g., based on a predetermined lookup function or another determination of a deviation between a data field of the exchange record and a uniform field corresponding thereto). At operation 710, a data enrichment source 260 can provide the enriched exchange data based on the receipt of a message from the issuing processor aggregator 102 (e.g., an entity translator 310 thereof). The enrichment data source 260 can provide the enriched data to the issuing processor 104, whereupon the exchange record can be updated to include the enriched data, at operation 712. At operation 714, the proprietary system receives an indication of the exchange record, which may be used to update an electronic ledger 114 (e.g., to reduce an available balance by an amount corresponding to a hold, pending charge, settled charge, or so forth).

The card network 108 can provide a message 716 including an indication of a further swipe action to the issuing processor 104. For example, the further swipe action can be swipe data 324 indicative of an adjustment to a prior authorization or pre-authorization (e.g., adding a tip to a restaurant check), reversing a transaction, or another adjustment to a transaction or other exchange. The issuing processor 104 can, responsive to receipt of the message 716, generate a further message 718 for provision to the issuing processor aggregator 102. At operation 720, upon a receipt of the message 718 by the issuing processor aggregator 102, the issuing processor aggregator 102 can associated the further swipe action associated with the indication of the swipe action received at operation 706. The issuing processor aggregator 102 can update various data structures (e.g., exchange records), and provide a message 722 indicating such an update to the proprietary system 110, which can update an electronic ledger 114 based thereupon. For example, the update of the electronic ledger 114 can include increasing an available balance responsive to an exchange cancellation or reversal, reducing another balance in response to an approval or settlement of an exchange, etc.

There may be instances in the computing infrastructure system described herein in which the issuing processor aggregator connects directly to a computing system instead of an issuing processor computing system to facilitate exchanges or the recording of exchanges. Such may be the case, for example, when the computing system is already connected with an issuing processor computing system and is connecting with the computing infrastructure system to use the electronic ledger that maintains a record of exchanges performed by different exchange cards. The issuing processor aggregator may be preconfigured or initialized to communicate with different issuing processor computing systems (e.g., configured to format messages in a defined manner to communicate via one or more APIs to the different issuing processor computing systems). However, the issuing processor aggregator may not be similarly configured to communicate with a computing system that operates as middleware between the issuing processor aggregator and an issuing processor computing system to which the computing system is already connected or configured to use as an issuing processor computing system.

To overcome these technical deficiencies, the issuing processor aggregator can host an application for a platform that generates one or more user interfaces that can be used to integrate issuing processor computing systems with the issuing processor aggregator through middleware computing systems. For example, a computing device (e.g., a remote computing device) of a computing system (e.g., a computing system that is configured to operate as middleware between the issuing processor aggregator and an issuing processor computing system) can establish a connection with the issuing processor aggregator. The computing device may do so via an API of the issuing processor aggregator. The issuing processor aggregator can generate and present one or more user interfaces, for example, at the computing device. The one or more user interfaces can provide different options for creating a card program and exchange cards for the card program. A user accessing the computing device can provide inputs to generate the card program and an exchange card for the card program over the established connection. Upon doing so, the issuing processor aggregator can generate one or more user interfaces that enable the user to configure the connection between the computing system and the issuing processor aggregator. Via the user interfaces, the user can provide inputs configuring the communication between the computing system and the issuing processor aggregator such that the issuing processor aggregator transmits data to the computing system, and the computing system can exchange data regarding exchange cards with the issuing processor computing system.

In some embodiments, the one or more user interfaces may be presented to a disparate computing device, such as may be connected via a communication network. The disparate computing device may be a mobile communication device, laptop, desktop, or any suitable computing device. The one or more interfaces may be presented via web browser. The one or more user interfaces may be accessible via login credentials associated with the computing system that is already connected with an issuing processor computing system. In this manner, the one or more user interfaces can be presented and facilitate user input from anywhere (e.g., anywhere connected or connectable to the Internet) to then configure the connection of the computing system with the issuing processor aggregator.

In one example, a user configuring the connection between the issuing processor aggregator and a computing system (e.g., a middleware computing system) can input pointers into a user interface provided to a computing device of the computing system. The pointers can be addresses (e.g., uniform resource locators (URLs)) or identifiers of endpoints within or at the computing system. The endpoints can be specific applications, computers, or servers of the computing system. The pointers can be used by webhooks of the issuing processor aggregator to push or pull data from the corresponding endpoints. The user can input different or the same pointers for different types of events. The types of events can include, for example, swipe event created, swipe created, swipe updated, card created, card status updated, etc. The issuing processor aggregator can detect an event, determine the type of the detected event, and identify the pointer associated with the type of event. The issuing processor aggregator can use the pointer to transmit a message to the endpoint associated with the pointer. The message can include data regarding the event. The computing system can receive the message at the endpoint and forward data from the message to the issuing processor computing system. In this way, the issuing processor aggregator can be configured over a network in real time to communicate with an issuing processor computing system through a middleware computing system, which can be connected with the issuing processor computing system. The issuing processor aggregator can be configured to connect with any number of issuing processor computing systems through the same or different middleware computing systems.

In some cases, the middleware computing system can store a mapping of tokens maintained by the issuing processor computing system to unique identifiers of an electronic ledger computing system in communication with the issuing processor aggregator. In such cases, the middleware computing system may receive exchange data regarding different exchanges performed through the issuing processor computing system that includes tokens of the exchange cards involved in the exchanges. The middleware computing system may use the mappings stored in memory to identify the unique identifiers of the exchange cards that map to the received tokens and transmit the unique identifiers to the issuing processor aggregator with the exchange data for the respective exchanges. The issuing processor computing system can receive the unique identifiers and the exchange data and forward the data to the electronic ledger computing system to update respective electronic ledgers based on the exchanges. Accordingly, the middleware system and the issuing processor aggregator can operate together as intermediary computing systems to enable the issuing processor computing system to update the electronic ledgers hosted by the electronic ledger computing system.

Additionally, the issuing processor aggregator can communicate with the middleware computing system in a configurable format. For example, the issuing processor aggregator can present a user interface at the computing device being accessed by the user that enables the user to configure the format and/or types of communication for the webhooks between the issuing processor aggregator and the middleware computing system. Through the user interface, the user can input the different types of data to include in messages and/or the types of methods of the messages from the issuing processor aggregator to the middleware computing system for the webhooks. The user can configure messages for different webhooks in different ways depending on the endpoints or computing devices to which the pointers for the webhooks point. Accordingly, the user interface can enable the user to connect the middleware system with the issuing processor aggregator to operate as middleware with an issuing processor computing system to which the middleware is already connected.

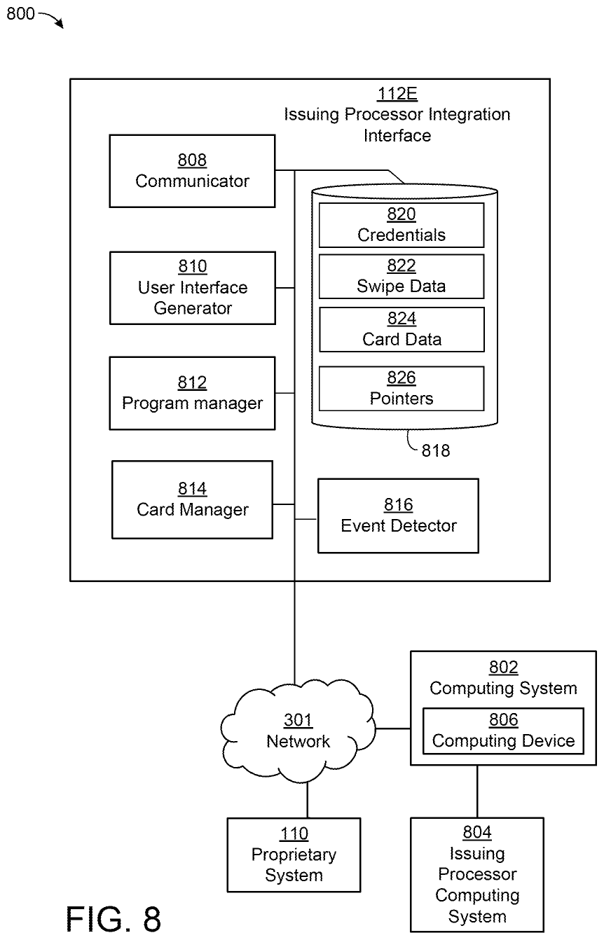

For example, FIG. 8 illustrates a system architecture of a system 800 for integrating an issuing processor computing system, according to some implementations. In brief overview, the system 800 can include the issuing processor integration interface 112E, a computing system 802, an issuing processor computing system 804, and the proprietary system 110. The issuing processor integration interface 112E can be the issuing processor integration interface 112E described with reference to FIG. 1. The issuing processor integration interface 112E can communicate with the computing system 802 over the network 301, which is shown and described with reference to FIG. 3. The proprietary system 110 can be the proprietary system 110 described with reference to FIG. 1. The issuing processor computing system 804 can be the same as the issuing processor 104E. The computing system 802 can operate as middleware for communication between the issuing processor computing system 804 and the issuing processor integration interface 112E. An example of the computing system 802 may be the adaptable connector 106 of FIG. 1. The issuing processor integration interface 112E can operate as middleware between the computing system 802 and the proprietary system 110. A user accessing a computing device 806 of the computing system 802 can access a user interface provided by the issuing processor integration interface 112E. Through the user interface, the user can create or otherwise configure creation of a connection between the issuing processor integration interface 112E and the computing system 802 to enable the computing system 802 to operate as middleware between the issuing processor computing system 804 and the issuing processor integration interface 112E. The system 800 may include more, fewer, or different components than shown in FIG. 8.

The computing system 802 can be owned by an entity that is attempting to connect with the issuing processor aggregator 102 through the issuing processor integration interface 112E. The computing system 802 can include the computing device 806 and/or one or more other computing devices. The computing devices within the computing system 802 can be or include different client devices and/or servers configured to process data. In one example, one or more of the computing devices can be client devices configured to be accessed by individuals, one or more of the computing devices can be edge devices (e.g., routers) configured to receive and/or transmit messages, one or more of the computing devices can be servers or other computing devices can be configured for data storage. The computing system 802 can include any combination of such computing devices. The computing system 802 can be, include, and/or host the adaptable connector 106, shown and described with reference to FIG. 1, in some embodiments.

The computing system 802 may have already been connected to the issuing processor computing system 804. For example, the computing system 802 may be configured to use or already have an active established connection with a computing device of the issuing processor computing system 804. The connection may be to facilitate exchanges (e.g., transactions) performed by exchange cards of the issuing processor computing system 804.

A user accessing the computing device 806 can connect the computing system 802 with the issuing processor integration interface 112E through user interfaces generated and/or provided by the issuing processor integration interface 112E. In doing so, the user can select options to generate a card program and/or generate one or more data objects for exchange cards under the card program. The user can provide inputs to configure communication between the issuing processor integration interface 112E and one or more endpoints (e.g., computing devices and/or applications stored by the computing devices) of or within the computing system 802. The issuing processor integration interface 112 can transmit messages to the different endpoints for different events. The computing system 802 can forward the messages or the data of the messages to the issuing processor computing system 804. In some cases, a user can input pointers to endpoints of the issuing processor computing system 804 for webhooks for one or more event types to skip communication to the middleware computing system, such as for data security to avoid transmitting confidential data to the middleware computing system.

The issuing processor integration interface 112E can include or interface with a communicator 808, a user interface generator 810, a program manager 812, a card manager 814, an event detector 816, and a data repository 818. The communicator 808, the user interface generator 810, the program manager 812, the card manager 814, and/or the event detector 816 each can include at least one processing unit or other logic device such as a programmable logic array engine, or module configured to communicate with a data repository 818 or database. The communicator 808, the user interface generator 810, the program manager 812, the card manager 814, and/or the event detector 816 can be separate components, a single component, or part of the issuing processor aggregator 102, and can include or interface with, or be components of, the system 100 of FIG. 1 or the system 800 of FIG. 8. The issuing processor integration interface 112E can include hardware elements, such as one or more processors, logic devices, or circuits. For example, the issuing processor integration interface 112E, like other components of the system 800 of FIG. 8, can include one or more components or structures of functionality of computing devices depicted in FIG. 20. The issuing processor integration interface 112E can be the same as or similar to an IPIF 112, shown and described with reference to FIG. 1. The issuing processor integration interface 112E can be or include one or more APIs, in some embodiments.

The data repository 818 can include one or more local or distributed databases, and can include a database management system. For example, the data repository 818 can include credentials 820, swipe data 822, or card data 824 (e.g., card records). The data repository 818 and the components 820, 822, and/or 824 can be the same as or similar to the corresponding components shown and described with respect to FIG. 3.

The communicator 808 can communicate with different computing devices. The communicator 808 may be or include one or more application programming interface (APIs) that facilitate communication between the issuing processor integration interface 112E and other computing devices, such as computing devices of the computing system 802 and/or computing devices of the issuing processor computing system 804.

The communicator 808 can establish connections with computing devices (e.g., the computing device 806 or computing devices of the computing system 802 and/or the issuing processor computing system 804). The communicator 808 can establish connections with the computing devices over the network 301, for example. To do so, the communicator 808 can communicate with the computers across the network. In one example, the communicator 808 can transmit syn packets to the computers (or the computers can transmit syn packets to the communicator 808) and establish the connections using a transport layer security (TLS) handshaking protocol. The communicator 118 can use any handshaking protocol to establish connections with the computers. The communicator 808 can establish a connection with the computing device 806 using such techniques.

The user interface generator 810 can generate user interfaces of a platform hosted by the issuing processor integration interface 112 or the issuing processor aggregator 102. The platform may be or may be associated with an application executed by the issuing processor aggregator 102 that enables communication with different issuing processors. The platform can do so through different interfaces (e.g., IPIFs 112), as described herein.

The user interface generator 810 can generate user interfaces that enable users at computers to connect the issuing processor integration interface 112 with middleware computing systems to communicate with issuing processor computing systems. For example, the user interface generator 810 can generate a user interface and present the user interface at the computing system 802. The user interface generator 810 can do so through the connection the communicator 808 established with the computing device 806. The user interface generator 810 can generate the user interface to include different forms or selectable options that can be selected or configured to receive inputs to generate a card program for the issuing processor computing system 804. Through the user interface, the user can select one or more parameters indicating rules or limits for exchange cards that can be generated or recorded for the card program. The different parameters can be enforced for cards that are generated or recorded under the card program.

The program manager 812 can manage a card program associated with cards and/or cardholders. The program manager 812 can do so in a similar manner to the manner described with reference to the program manager 304. For example, the program manager 812 can receive values of one more data fields associated with a card program. The values can be parameters for the card program. The program manager 812 can receive the values of the one or more data fields through the user interface being presented at the computing device 806. The program manager 812 can store received values for the data fields in a record or data structure in memory and/or in data field-value pairs of data objects generated for exchange cards generated under the card program. The stored values can operate as rules or include data for the different exchange cards that are created through the card program. The card program may correspond with the computing system 802 and the issuing processor computing system 804 such that any exchange cards that are created for the computing system 802 and the issuing processor computing system 804 can have the parameters of the card program input through the user interface.

In some embodiments, users can input identifications of issuing processors or issuing processor computing systems into a user interface generated and/or presented by the user interface generator 810. Users may do so, for example, to indicate issuing processor computing systems that the users seek to connect with the issuing processor integration interface 112E. For example, when accessing the user interfaces provided by the user interface generator 810 to the computing device 806, the user can input an identification (e.g., a string of characters indicating a name) of the issuing processor computing system 804. The user can input the identification of the issuing processor computing system 804 into the user interface and then provide inputs for a card program the user interface or a different user interface generated by the user interface generator 810. Such may be advantageous, for example, when the computing system 802 is connected with multiple issuing processor computing systems and a card program and/or cards generated under the card program are associated with only one of the issuing processor computing systems. The program manager 812 can receive the inputs and store an association between the issuing processor computing system 804, the card program, and/or the parameters for the card program in memory.

Through the user interface, the user can input pointers for the card program. The pointers can be addresses or uniform resource locators (URLs) that point to different endpoints (e.g., applications and/or computing devices) within the computing system 802. The endpoints can be to the computing device 806 or any other computing device of the computing system 802. The pointers can be used by webhooks to automatically communicate with the endpoints, in some cases responsive to an event occurring or being detected. For example, the user can input a pointer into the user interface that includes the address of the computing device 806 or another computing device of the computing system 802. The pointer can be stored in memory of the issuing processor integration interface 112E. Responsive to detecting an event, the issuing processor integration interface 112E can execute the webhook using the input pointer to transmit a message with data regarding the event to the endpoint of the pointer within the computing system 802. Examples of events that can be detected include, but are not limited to swipe event created, swipe created, swipe updated, card created, and/or card status updated.

The user can input multiple pointers into the user interface that correspond with different types of events (e.g., swipe event created, swipe created, swipe updated, card created, and/or card status updated). For example, the user can input a pointer to a first endpoint within the computing system 802 for a first type of event and a second endpoint within the computing system 82 for a second type of event. The user may do so, for example, because different applications or computing devices within the computing system 802 may be configured to process data relating to different types of events. The user can select an event type and input a pointer for the event type. The user can repeat this process for any number of event types. In doing so, the user can input the same pointers for different event types and/or different pointers for different event types. In some cases, the user can use the same pointer for each event type. The program manager 812 can receive input pointers and store the pointers in the data repository 818 as pointers 826 with stored associations with the card program for which the pointers were input.

In some embodiments, the user interface generator 810 can generate a user interface that enables a user to configure the format and/or the data to include in the webhook messages to the computing system 802. For example, the user interface generator 810 can present a user interface at the computing device 806. The user interface can include one or more forms that are configured to receive a format for communication by the webhook with a particular endpoint of the computing system 802 that corresponds with a pointer. Examples of data that can be included in the form can include, but are not limited to, event name, context, loan-id, trace, auth, attempt number, etc. The program manager 812 can receive inputs of the format from the form as input by the user. The program manager 812 can store the inputs with stored associations with the pointer in the data repository 818. Accordingly, when an event that corresponds with the pointer is detected, the communicator 808 can use a webhook to generate a message according to the format and/or including the data of the format and transmit the generated message to the endpoint associated with the pointer.

In some embodiments, the user interface includes a form that is configured to receive a type of method for communication using the pointer. Examples of such types of methods can include, but are not limited to, GET, POST, PUT, PATCH, DELETE, HEAD, OPTIONS, CONNECT, and TRACE. The user can input a type of method into the user interface. The program manager 812 can receive the input type of method and store the type of method with a stored association with the pointer in the data repository. Accordingly, when an event that corresponds with the pointer is detected, the communicator 808 can use a webhook to generate a message according to the method and transmit the message to the endpoint associated with the pointer.

The card manager 814 can manage the creation and use of different exchange cards. In doing so, the card manager 814 can generate data objects (e.g., data structures with different field-value pairs) for different exchange cards. The card manager 814 can generate the data objects for exchange cards of card programs generated and/or managed by the program manager 812. For example, the computing device 806 (or another computing device) can provide inputs into a user interface generated by the user interface generator 810 to generate one or more exchange cards. In doing so, the card manager 814 may enforce the parameters of the card program (e.g., cause the card to follow any rules of the card program) that the user created through a similar or the same user interface. The card manager 814 can input the parameters of the card program into the data objects of the exchange cards to cause the data object to include one or more data field-value pairs that correspond to a different parameter of the one or more parameters and/or to otherwise enforce the parameters of the card program, in some embodiments. The data object of the exchange card can correspond to the issuing processor computing system 804 because the data object is generated for a card program that is associated with the issuing processor computing system 804, for example. The card manager 814 can generate data objects for any number of exchange cards associated with the issuing processor computing system 804.

The event detector 816 can detect events based on messages from the proprietary system 110. For example, the proprietary system 110 can transmit the issuing processor integration interface 112E messages regarding different occurrences at the proprietary system 110, such as swipe event created, swipe created, swipe updated, card created, and/or card status updated. Such events can involve an electronic ledger that the proprietary system 110 stores and/or hosts to manage exchanges and/or accounts for different issuing processor computing systems, such as the issuing processor computing system 804.

The proprietary system 110 can transmit messages regarding swipes or exchanges responsive to updating an electronic ledger hosted by the proprietary system 110 for the swipes or exchanges. For instance, the issuing processor integration interface 112E can receive exchange data regarding a swipe by an exchange card from the issuing processor computing system 804 or the computing system 802 after the computing system 802 receives the exchange data from the issuing processor computing system. The issuing processor integration interface 112 can transmit the data to the proprietary system 110 (e.g., after converting the data into a uniform format, as described herein). The proprietary system 110 can update an electronic ledger to indicate the exchange for the exchange card and transmit a record of the update in a message back to the issuing processor integration interface 112E. The event detector 816 can detect the message containing the record. The communicator 808 can identify a pointer (e.g., a pointer corresponding to a swipe event) from the data repository 818 and use the pointer to automatically transmit the record to the endpoint of the computing system 802 that corresponds to the pointer. In cases in which the issuing processor integration interface 112E receives an identification of an issuing processor computing system for event (e.g., for card program of the event), the communicator 808 can include the identification of the issuing processor computing system in the message with the record. The computing system 802 can forward the message to the issuing processor computing system 804 or extract data from the message and forward the extracted data from the message to the issuing processor computing system 804. The computing system 802 can forward the data of the message to the issuing processor computing system 804 responsive to identifying the identification of the issuing processor computing system 804 in the message, in some embodiments.

In another example, a user can access a platform hosted by the proprietary system 110 using a client device. Through the platform, the user can create an exchange card for the card program. The user can create the exchange card to correspond with the parameters of the card program. The proprietary system 110 can generate a unique identifier for the exchange card. The proprietary system 110 can transmit a record of the creation of the exchange card, including a unique identifier for a created card, to the issuing processor integration interface 112E. The event detector 816 can detect receipt of the record and parse the record. The event detector 816 can determine the type of event to be a card creation event based on the content of the record, such as by applying one or more rules to the data in the record, or based on an identification of the event type in the record. The event detector 816 can identify the pointer that corresponds to the card creation event type and use the pointer to transmit a message containing the data (e.g., the unique identifier for the generated exchange card) to the computing system 802.

Responsive to receiving the message containing the data for the exchange card generation event from the issuing processor integration interface 112E, the computing system 802 can forward the message or data from the message to the issuing processor computing system 804. The computing system 802 can also store the unique identifier for the exchange card in memory of a computing device of the computing system 802. The issuing processor computing system 804 can receive the message and generate a record for the generated exchange card in memory of a computing device of the issuing processor computing system 804. The issuing processor computing system 804 can generate a token (e.g., using random number generation techniques or by performing a function, such as a hash or another function, on the unique identifier for the exchange card) for the exchange card in response to receiving the message indicating the creation of the exchange card. The issuing processor computing system 804 can store the token in memory and transmit the token to the computing system 802.

The computing system 802 can generate a mapping. The mapping can be a mapping between the unique identifier for the exchange card and the token for the exchange card. In one example, the mapping can be a stored association between the two values such as the unique identifier for the exchange card and the token being on the same line of a table or relating to each other in a data object or data structure for the exchange card stored in the computing system 802. In some embodiments, the issuing processor integration interface 112E can similarly store a mapping between the token and the unique identifier for the exchange card after receiving the token from the computing system 802 or the issuing processor computing system 804. The computing system 802 and/or the issuing processor integration interface 112E can store such mappings for any number of exchange cards and generate such mappings over time as the exchange cards are generated.

The computing system 802 can use the stored mappings between the tokens and the unique identifiers to complete exchanges or otherwise update the electronic ledger stored on the proprietary system 110. For example, the exchange card may be swiped to perform an exchange. Upon doing so, data for the exchange can be transmitted or communicated to the issuing processor computing system 804 (e.g., from a card network 108). The exchange data can include the token for the exchange card and/or any other data relating to the exchange (e.g., exchange amount, product or service purchased, etc.). In some embodiments, the issuing processor computing system 804 can authenticate or authorize the exchange. The issuing processor computing system 804 can transmit, in some cases in response to authorizing or authenticating the exchange, the exchange data with the token to the computing system 802. The issuing processor computing system 804 can include an indication of the authentication in the message to the computing system 804 when authentication or authorization is performed at the issuing processor computing system 802, in some cases. The computing system 802 can identify the token and use a stored mapping to identify the unique identifier for the exchange card that corresponds to the token. The computing system 802 can transmit the unique identifier with the data (e.g., the exchange data and/or the indication of the authentication or authorization) the computing system 802 received from the issuing processor computing system 804 to the issuing processor integration interface 112E. In some cases, the computing system 802 can do so based on or responsive to identifying the authentication or authorization indication for the exchange. The issuing processor integration interface 112E can receive the unique identifier and data for the exchange and transmit or forward the unique identifier and data to the proprietary system 110. The issuing processor integration interface 112E can transmit the authorization or authentication indication for the exchange with the unique identifier and data, in some cases.

The proprietary system 110 can update an electronic ledger for the exchange card that corresponds to the unique identifier. The proprietary system 110 can do so based on the exchange data of the exchange. In some cases, the proprietary system 110 can update the electronic ledger in response to identifying the authorization or authentication indication for the exchange. The proprietary system 110 can transmit a record indicating the update to the issuing processor integration interface 112E (e.g., the issuing processor aggregator 102).

The event detector 816 can identify the record and parse the record to determine a type of event for the record. The event detector 816 can determine the type of event to be a swipe. Responsive to doing so, the communicator 808 can identify the pointer that corresponds to a swipe event to the computing system 802 from the data repository 818. The communicator 808 can execute a webhook using the pointer to automatically push or transmit the record for the exchange in a message to the computing system 802. The computing system 802 can receive the record in the message and forward the record or data of the record to the issuing processor computing system 804. The event detector 816 can transmit messages to the computing system 802 using pointers that correspond to any type of event responsive to detecting the events.

The events can be configured on a per-issuing processor computing system basis, a per-middleware computing system basis, a per-card program basis, or a per-card (e.g., per exchange card) basis. For example, the events and webhooks can be configured to be applicable to each event that is detected for a specific issuing processor computing system, a specific middleware computing system, a specific card program, or a specific card such that the issuing processor integration interface 112E uses sets of webhooks and/or pointers that are specific to different issuing processor computing systems, middleware computing systems, card programs, and/or cards.

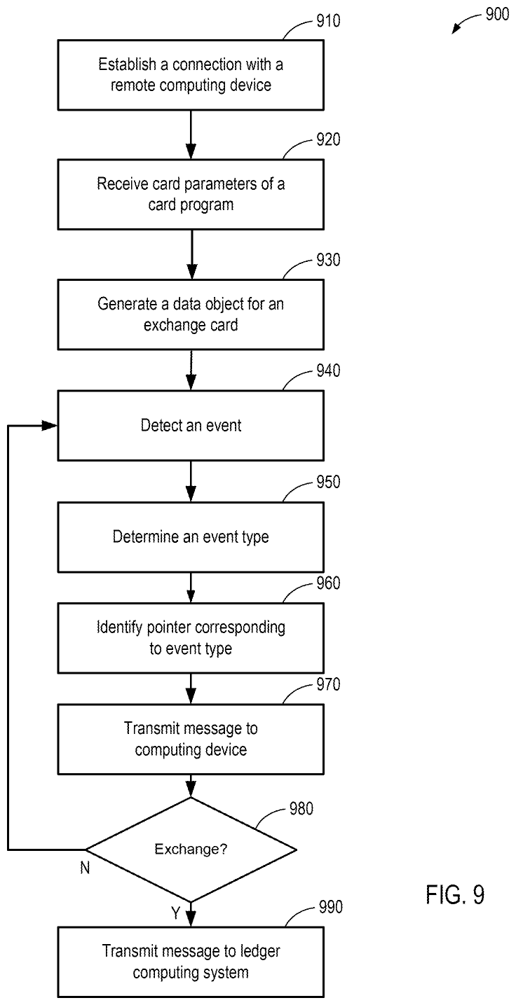

FIG. 9 is a flowchart of a method 900 to integrate an issuing processor computing system, according to some implementations. Various components of the system 100 (e.g., the issuing processor aggregator 102, the issuing processors 104, the proprietary system 110, etc.) of FIG. 1 or the system 800 (e.g., the issuing processor integration interface 112E, the computing system 802, the issuing processor computing system 804, the proprietary system 110, etc.) can perform the method 900. In some cases, at least one circuit or processing unit of the component of the system 100 or the system 800 can perform the method 900. Further, any computing device composed of hardware, software, or a combination of hardware and software described herein can be configured to perform method 900.

In broad overview of the method 900, at block 910, a processor can establish a connection with a remote computing device. At block 920, the processor can receive card parameters of a card program. At block 930, the processor can generate a data object for an exchange card. At block 940, the processor can detect an event regarding the exchange card. At block 950, the processor can determine an event type. At block 960, the processor can identify a pointer corresponding to the event type. At block 970, the processor can transmit a message to a computing device associated with the pointer. At block 980, the processor can determine whether an exchange occurred. At block 990, the processor can transmit a message to a ledger computing system. Additional, fewer or different operations may be performed depending on the particular arrangement. In some embodiments, some or all operations of method 900 may be performed by one or more processors executing on one or more computing devices, systems or servers. In various embodiments, each operation may be re-ordered, added, removed or repeated.

At block 910, a processor (e.g., a processor of the issuing processor aggregator 102, the issuing processor integration interface 112, etc.) can establish a connection with a remote computing device. The remote computing device can be a computing device or associated with a computing system (e.g., a remote computing system). The computing system may be owned by or associated with an entity. The computing system may be connected with an issuing processor (e.g., an issuer processor) computing system configured to approve or decline exchanges, settle exchanges, and/or maintain a record of cardholder data. The computing system may connect with the processor to communicate with an electronic ledger computing system that stores an electronic ledger to maintain a record of exchanges that are performed through different issuing processor computing systems and/or exchanges that are performed through different accounts associated with or of the issuing processor computing systems (e.g., accounts for which the issuing processor computing systems also maintains records).

At block 920, the processor can receive card parameters of a card program. The card parameters can include one or more rules for different exchange cards that can be generated through the processor or the electronic ledger computing system, such as spending limits or account numbers. The processor can receive the card parameters after a user inputs the card parameters into a user interface provided by the processor, for example. The parameters can include an identification of the issuing processor computing device to which the computing system is connected. The processor can store the card parameters in memory.

The processor can receive a pointer. The pointer can be a pointer of the card program. The pointer can be a URL or another address to an application and/or computing device of the computing system operating as middleware between the processor and the issuing processor computing system. The processor can receive the pointer through a user interface after a user inputs the pointer into the user interface. In some embodiments, the processor can receive multiple pointers that correspond to different event types. The pointers can be configured to be used by webhooks to transmit or push data to different endpoints of the computing system.

At block 930, the processor can generate a data object for an exchange card. The data object can be a table or another type of data object configured to contain or store data for the exchange card. The processor can generate the data object to include one or more data field-value pairs. The data field-value pairs can correspond to different parameters of the card program and/or any input parameters from a user. The data object can correspond to the issuing processor computing system because the exchange card of the data object was generated for the computing system and the issuing processor computing system.

At block 940, the processor can detect an event regarding the exchange card. The processor can detect the event by receiving a message. The processor can receive the message from another computing device, such as a proprietary computing system (e.g., a ledger computing system) that is configured to store electronic ledgers for different accounts and/or issuing processor computing systems. The processor can detect such an event responsive to receiving the message.

At block 950, the processor can determine an event type. Event types can include, but are not limited to, swipe event created, swipe created, swipe updated, card created, card status updated, etc. The processor can determine the event type by querying or parsing the message. For example, the message can contain data regarding the event. The processor can identify or extract data or values from the message. The processor can apply one or more rules to the data or values of the message that each corresponds to a different event type. For instance, the processor can apply a rule that corresponds to a swipe to the data or values of the message by determining an exchange amount for an exchange is in the message and/or whether there is an MCC code in the message. In some embodiments, the message can contain an identification of the event type, and the processor can determine the event type by identifying the identification in the message. The processor can determine the event type in any manner and for any type of event.

At block 960, the processor can identify a pointer corresponding to the event type. The pointer can be to a computing device of the computing system and/or an application stored or hosted by a computing device of the computing system. To identify the pointer, the processor can identify the mappings of pointers to event types in memory. The processor can do so by first identifying the mappings for the computing system and the issuing processor computing system. The processor can identify the pointer (e.g., the URL) for the determined event type from the mapping.

At block 970, the processor can transmit a message to a computing device associated with the pointer. In instances in which the pointer is to an application executed by the computing device, the processor can transmit the message to the application of the computing device. The processor can transmit the message to the computing device using a webhook associated with the identified pointer. The processor can transmit the message to the computing device by forwarding the message that the processor received that triggered the detection of the event or by generating a new message from the data in the message that triggered the detection of the event and forwarding the message to the computing device.

The computing device of the computing system can forward data of the message from the processor to the issuing processor computing system connected to the computing system. The computing device can do so, for example, by forwarding the message to the issuing processor computing system or by extracting the data of the message, generating a new message using or including the extracted data, and transmitting the new message to the issuing processor computing system. The issuing processor computing system can receive the message from the computing device and update a locally store database based on the data in the message (e.g., update a ledger to indicate completion of an exchange, creation of a new card, or any other update depending on the type of the event). The processor, computing device, and/or issuing processor computing system can repeat the operations described with respect to blocks 940-970 over time to enable the computing system to operate as middleware between the processor and the issuing processor computing system.

At block 980, the processor can determine whether an exchange occurred. The processor can do so by monitoring messages received from the computing system and/or the issuing processor computing system. The processor can receive messages from the computing system and/or the issuing processor computing system over time and parse the data of the messages using one or more rules. The one or more rules can indicate a message is for an exchange responsive to at least one of the one or more rules being satisfied. The one or more rules can be satisfied based on a message including one or more specific types of data, such as an exchange amount, a unique identifier of an exchange card, and/or an authorization indication. Responsive to determining a rule is satisfied, the processor can determine a message pertains to an exchange.

Responsive to the processor determining a message is for an exchange, At block 990, the processor can transmit a message to a ledger computing system. The processor can transmit the message for the exchange to the ledger computing system only responsive to determining the exchange is authorized (e.g., contains an indication of authorization), in some embodiments. The ledger computing system can receive the message, update an electronic ledger for the exchange card of the exchange, and transmit a record indicating the update (e.g., a total value of the ledger or any other data regarding the ledger for the exchange card subsequent to the update) to the processor. The processor can receive the message, detect an event based on receipt of the message, determine the event type to be a swipe event, and transmit a message to an endpoint of the computing system using the URL that corresponds to the event type. The endpoint of the computing system can receive the message and forward the data of the message to the issuing processor computing system. The issuing processor computing system can update the database based on the data of the message from the ledger computing system. The processor, computing device, and/or issuing processor computing system can repeat the operations described with respect to blocks 940-990 over time to enable the computing system to operate as middleware between the processor and the issuing processor computing system.

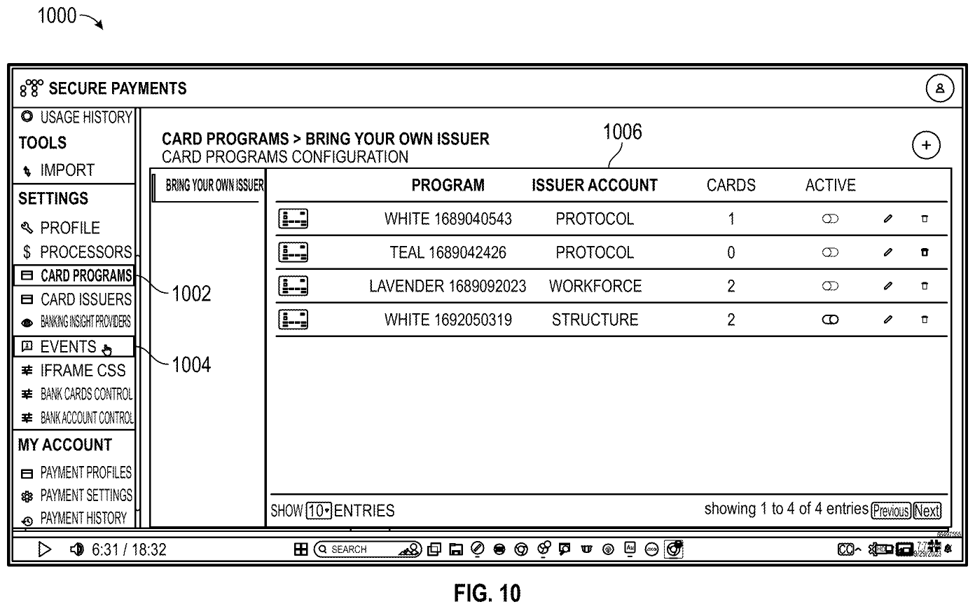

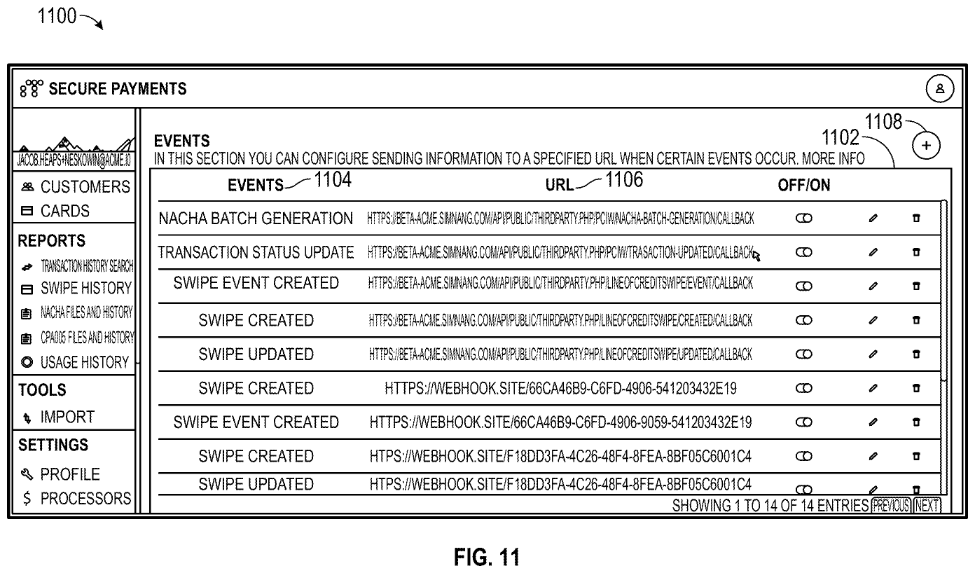

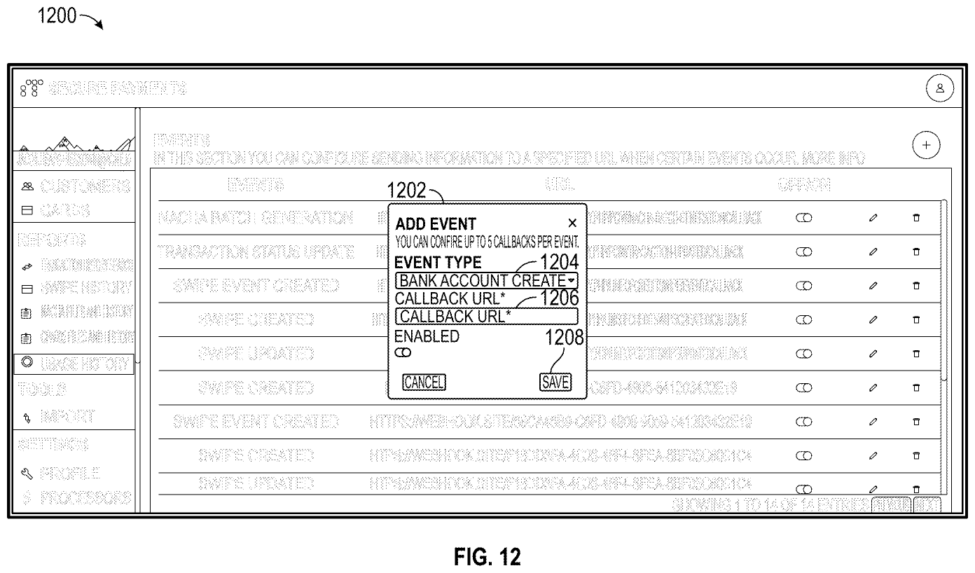

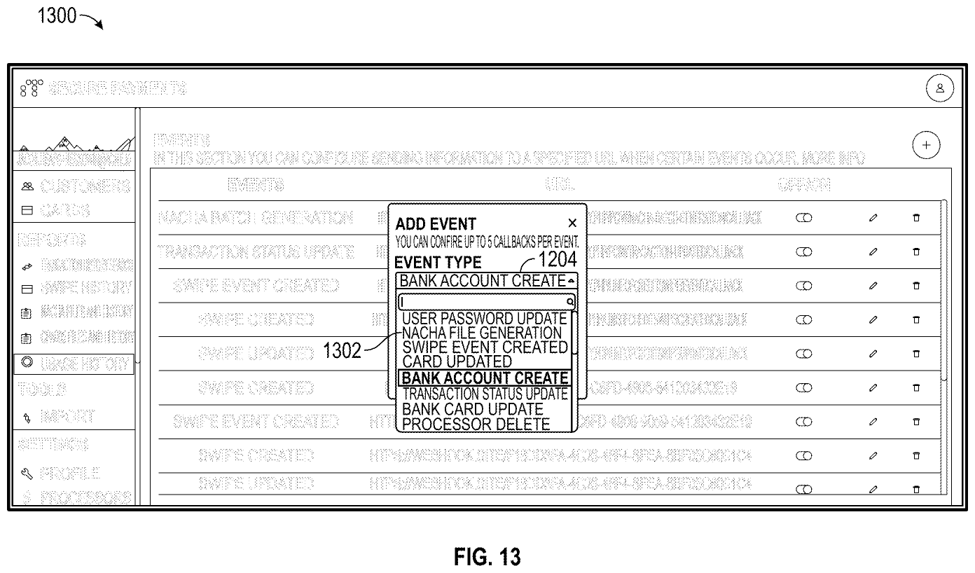

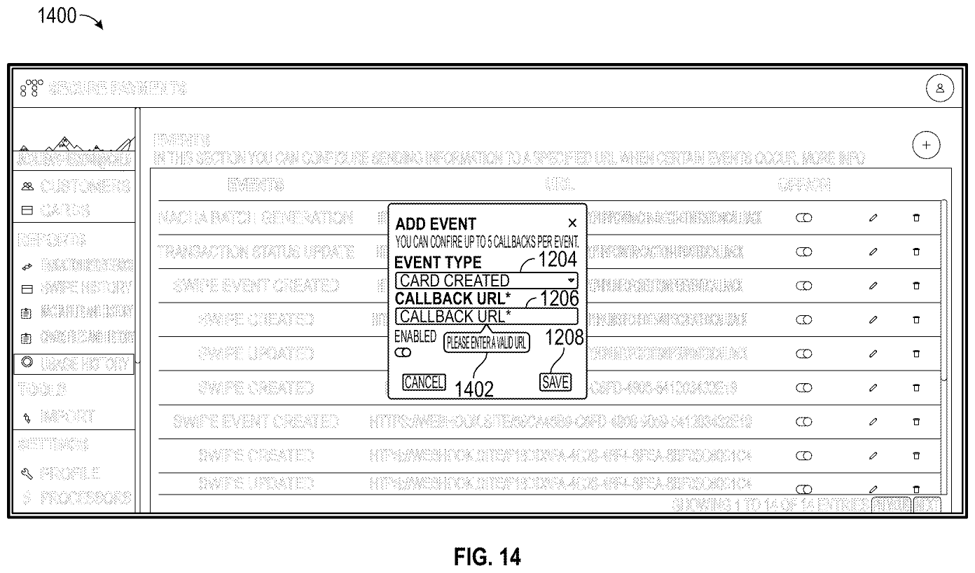

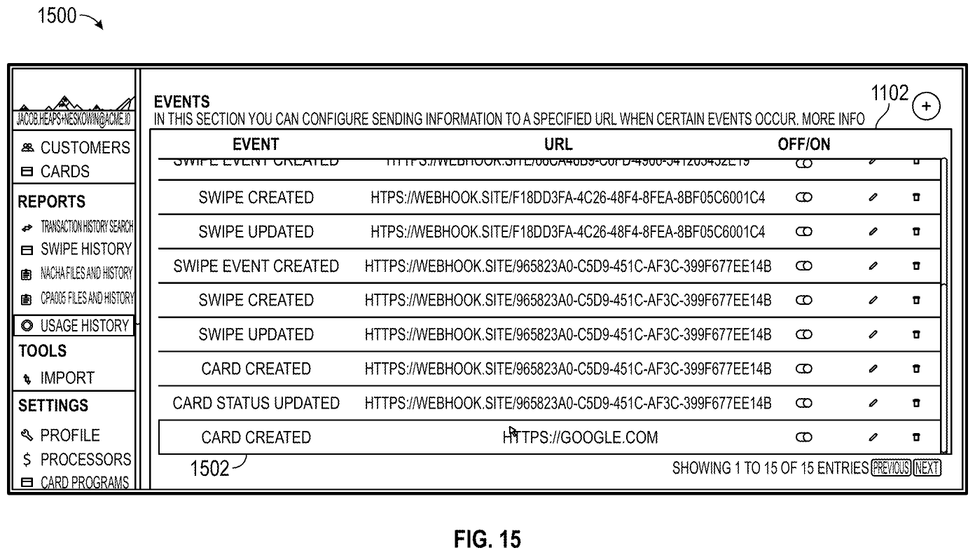

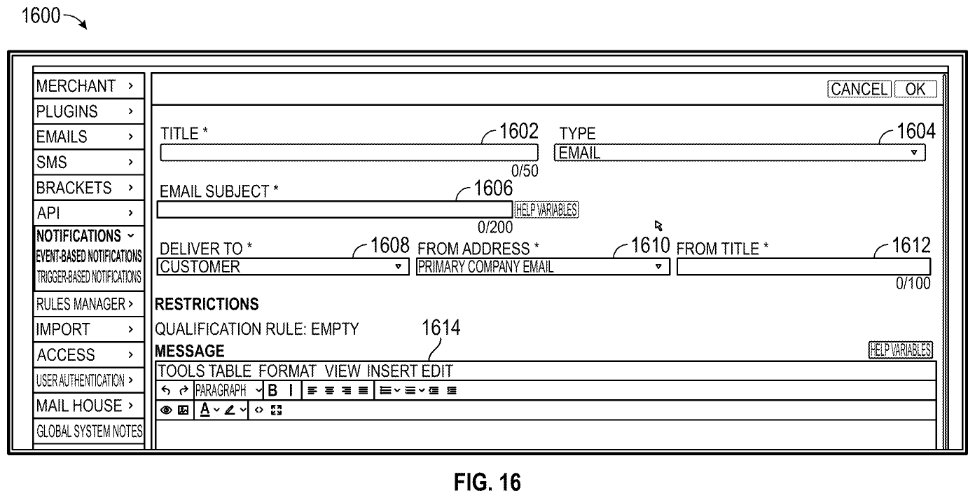

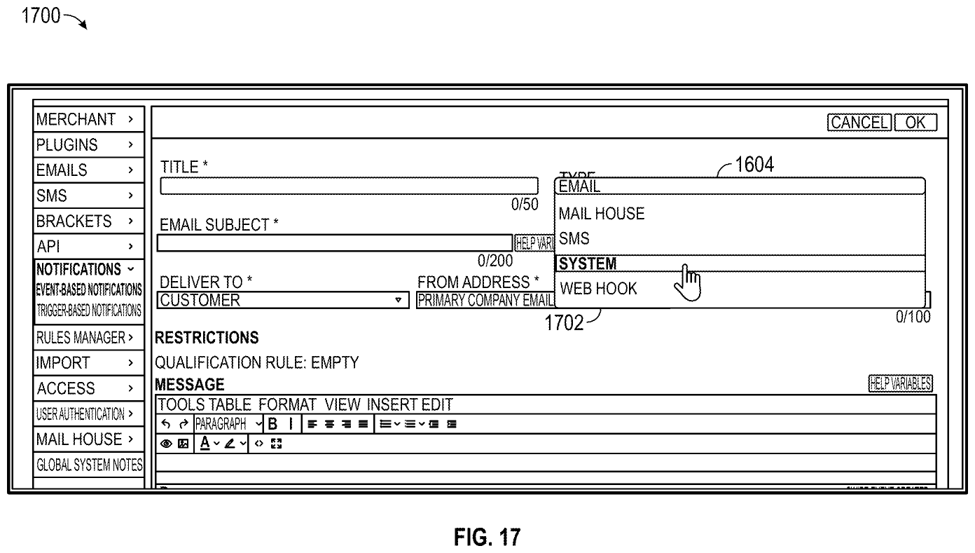

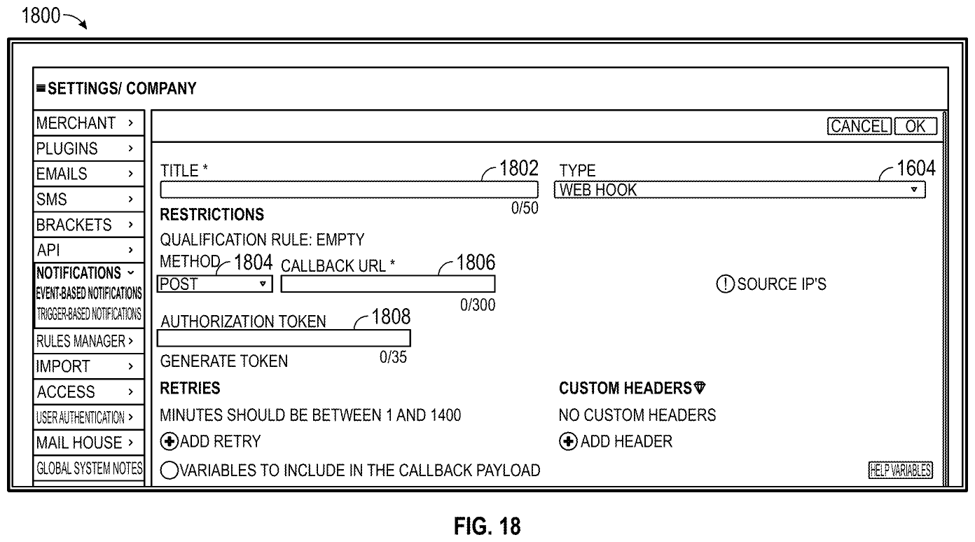

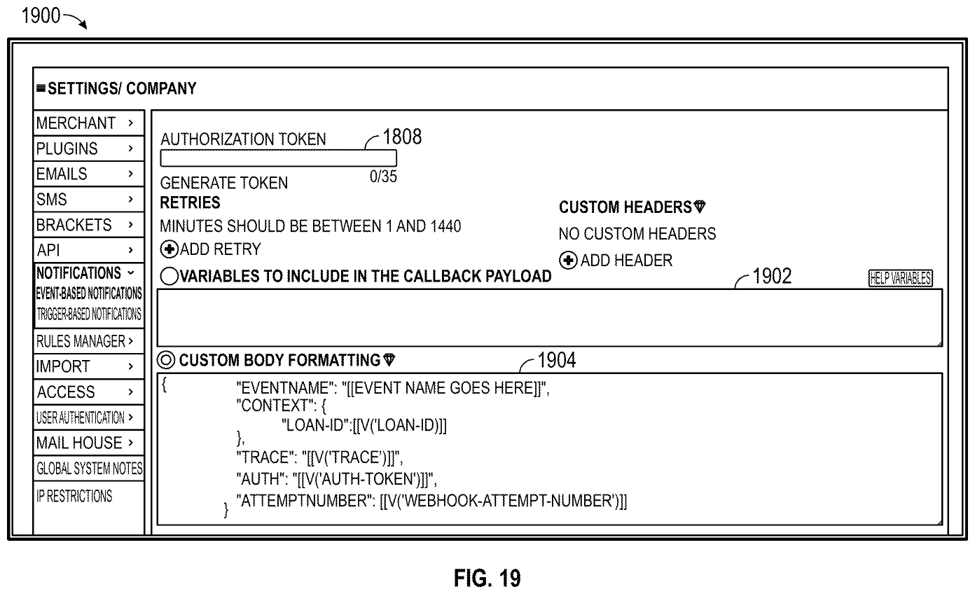

Referring to FIGS. 10-19, depicted are example user interfaces 1000-1900 of a computing device for integrating an issuing processor computing system, according to some implementations. A computing device (e.g., the computing device 806) can communicate with a data processing system (e.g., the issuing processor aggregator 102 or the issuing processor integration interface 112E) to receive the user interfaces 1000-1900. A user accessing the computing device can select different options displayed on the user interfaces 1000-1900 or provide inputs into the user interfaces 1000-1900 to integrate a computing system (e.g., the computing system 802) with the data processing system as middleware between the issuing processor integration interface 112E and an issuing processor computing system (e.g., the issuing processor computing system 804) to which the computing system was already connected. The user interface 1000-1900 can be depicted in a sequential order that the user may view and provide inputs into the user interfaces 1000-1900 for the integration, in some embodiments.

For example, the data processing system can present the user interface 1000 at the computing device by executing an application of a platform hosted by the data processing system. The user interface 1000 can include a card programs tab 1002 and an events tab 1004. The user may have selected the card programs tab 1002 on another user interface of the platform to view the user interface 1000. The user interface 1000 can depict data regarding different card programs that the user has configured through the platform in a list of card programs 1006. The list of card programs 1006 can include the names or identifications of the card programs, issuing processing computing systems associated with the respective card programs, and/or counters indicating the number of card that have been generated or issued under the respective card programs. The user may have previously input the identifications of the issuing processing computing system when configuring the respective card programs. The user can select the events tab 1004 to view the user interface 1100.

The user interface 1100 can include a list of event types 1102 for the account set up for the computing system of the computing device presenting the user interface 1100. The list of event types 1102 can include rows for different event types 1104. The rows for different event types 1104 can include pointers 1106. The pointers 1106 can be addresses (e.g., URLs) of endpoints (e.g., applications or computing devices) of the computing system for the respective event types. The user can edit the event types or pointers of the individual rows or select an add event option 1108 to add an event and/or pointer to the list of event types 1102.

Responsive to receiving a selection of the add event option 1108, the user interface 1200 can be presented (e.g., by the data processing system) on the display of the computing device. The user interface 1200 can include a pop-up display 1202 that overlays the contents of the user interface 1100. The pop-up display 1202 can include forms that can be used to add an event to the list of event types 1102. For example, the pop-up display 1202 can include an event type drop-down menu 1204 and a pointer field 1206. The user can select an event type from the event type drop-down menu 1204 to select an event type to add to the list of event types 1102 and input a value or address into the pointer field 1206 to provide the pointer to a computing device of the computing system of the computing device for a webhook to use to push data upon detection of an event of the event type. The user can select a save button 1208 to cause a new entry for the selected event type and input pointer to be added to the list of event types 1102.

For example, responsive to selecting the event type drop-down menu 1204, the user interface 1300 can be presented at the computing device. The user interface 1300 can include a list of selectable event types 1302. A user can select an event type from the list of selectable event types 1302 or input a value to select an event type for the entry to be added to the list of event types 1102.

The user can select a card created event type to cause the user interface 1400 to be presented at the computing device. The user interface 1400 can include the event type drop-down menu 1204 updated to indicate the selected event type of card created and instructions 1402 to update the pointer field 1206 with a value. Subsequent to inputting the value in the pointer field 1206, the user can select the save button 1208 to add an entry into the list of event types 1102 for the selected event type of card created and the input value for the pointer for the event type. The user interface 1500 illustrates an entry 1502 in the list of event types 1102 as such an added entry.

As illustrated in the user interface 1500, a single event type can correspond to multiple pointers or URLs. Upon detecting an event of an event type that corresponds to multiple pointers, the data processing system can send the same or identical messages with webhooks using each of the pointers for the event type. Such can be advantageous, for example, for testing purposes or if different computing devices or applications of the computing system are configured to process the same data for the event type differently.

The user interface 1600 can include one or more forms that can be used to format or configure messages that are sent to the computing system. The user interface 1600 can be used to format messages that are sent by the data processing system for individual event types depicted in the list of event types 1102 or by a proprietary computing system for which the data processing system operates as middleware with the computing system. The user interface 1600 includes forms for generating email messages. The user interface 1600 can include a title field 1602, a message type drop-down menu 1604, an email subject field 1606, a deliver to field 1608, a from address field 1610, a from title field 1612, and a message body field 1614. The fields 1602, 1606, 1608, 1610, and 1612 can each be configured to receive values for headings of the email such as the title, subject, the recipients, and the delivering addresses. The message body field 1614 can be configured to receive the content of the email. The user can provide inputs into each of the fields 1602 and 1606-1614 to configure an email to send responsive to an event occurring (e.g., an email to send responsive to a particular type of event occurring). The user can select the message type drop-down menu 1604 to change the type of message to send responsive to detecting an event.

For example, responsive to selecting the message type drop-down menu 1604, the user interface 1700 can be presented at the computing device. The user interface 1700 can be the same as the user interface 1600 but with the message type drop-down menu 1604 selected and displaying different types of messages that can be transmitted responsive to detecting an event. The user can select a webhook option 1702 to select a webhook message type for the event.

Responsive to detecting a selection of the webhook option 1702, the user interface 1800 can be presented at the computing device. The user interface 1800 can be used to format messages that are to be sent via webhooks responsive to detecting an event, either by the proprietary computing system or by the data processing system. The user can input values into the fields of the user interface 1800 to enable the data processing system to send messages to the computing system in a format or configuration that the endpoint of the computing system can read and/or process. The user interface 1800 can include at least the message type drop-down menu 1604, a title field 1802, a method drop-down menu 1804, a pointer field 1806, and an authorization token field 1808. The title field 1802 can be configured to receive the title to be included in the messages (e.g., in the headers of the messages) to the endpoint. The method drop-down menu 1804 can be used to select a method for messages for the event type or the webhook. The pointer field 1806 can indicate the endpoint within the computing system or the issuing processor computing system for messages sent by the webhook. The authorization token field 1808 can be configured to receive authorization tokens that can be included in the messages for the webhook to indicate the messages are authorized to be transmitted to the endpoint of the webhook. The user can input values into the fields 1802-1808 to configure the messages sent by the webhook responsive to the data processing system or the proprietary computing system detecting an event.

The user can scroll down on the user interface 1800 to view the user interface 1900. The user interface 1900 can include the authorization token field 1808, a variables field 1902, and a custom body formatting field 1904. The variables field 1902 can be configured to receive variables to include in the messages sent using the webhook. The custom body formatting field 1904 can include a format with data to include in messages sent using the webhook. The user can select to use data from one of the variables field 1902 or the custom body formatting field 1904 to transmit the messages using the webhook. The user can select a save button (not shown) on the user interface 1800 or 1900 to save the data for messages transmitted using the webhook.

### B. Computing Environment

Referring now to FIG. 20, a depiction of a computer system 2000 is shown. The computer system 2000 can be used, for example, to implement an issuing processor aggregator 102, proprietary system 110, issuing processors 104, card networks 108, and/or various other example systems described in the present disclosure. The computing system 2000 includes a bus 2005 or other communication component for communicating information and a processor 2010 coupled to the bus 2005 for processing information. The computing system 2000 also includes main memory 2015, such as a random-access memory (RAM) or other dynamic storage device, coupled to the bus 2005 for storing information, and instructions to be executed by the processor 2010. Main memory 2015 can also be used for storing position information, temporary variables, or other intermediate information during execution of instructions by the processor 2010. The computing system 2000 may further include a read only memory (ROM) 2020 or other static storage device coupled to the bus 2005 for storing static information and instructions for the processor 2010. A storage device 2025, such as a solid-state device, magnetic disk, or optical disk, is coupled to the bus 2005 for persistently storing information and instructions.

The computing system 2000 may be coupled via the bus 2005 to a display 2035, such as a liquid crystal display, or active matrix display, for displaying information to a user. An input device 2030, such as a keyboard including alphanumeric and other keys, may be coupled to the bus 2005 for communicating information, and command selections to the processor 2010. In another implementation, the input device 2030 has a touch screen display 2035. The input device 2030 can include any type of biometric sensor, a cursor control, such as a mouse, a trackball, or cursor direction keys, for communicating direction information and command selections to the processor 2010 and for controlling cursor movement on the display 2035.

In some embodiments, the computing system 2000 may include a communications adapter 2040, such as a networking adapter. In various illustrative implementations, any type of networking configuration may be achieved using communications adapter 2040, such as wired (e.g., via Ethernet), wireless (e.g., via Wi-Fi, Bluetooth), satellite (e.g., via GPS) pre-configured, ad-hoc, LAN, WAN.

According to various implementations, the processes that effectuate illustrative implementations that are described herein can be achieved by the computing system 2000 in response to the processor 2010 executing an implementation of instructions contained in main memory 2015. Such instructions can be read into main memory 2015 from another computer-readable medium, such as the storage device 2025. Execution of the implementation of instructions contained in main memory 2015 causes the computing system 2000 to perform the illustrative processes described herein. One or more processors in a multi-processing implementation may also be operated to execute the instructions contained in main memory 2015. In alternative implementations, hard-wired circuitry may be used in place of or in combination with software instructions to implement illustrative implementations. Thus, implementations are not limited to any specific combination of hardware circuitry and software.

That is, although an example processing system has been described in FIG. 20, implementations of the subject matter and the functional operations described in this specification can be carried out using other types of digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the implementations of FIG. 20 as singular, stand-alone devices, one of ordinary skill in the art will appreciate that, in some embodiments, the computing system 2000 may include virtualized systems and/or system resources. For example, in some embodiments, the computing system 2000 may be a virtual switch, virtual router, virtual host, or virtual server. In various implementations, computing system 2000 may share physical storage, hardware, and other resources with other virtual machines. In some embodiments, virtual resources of the network (e.g., the network 301 of FIG. 3) may include cloud computing resources such that a virtual resource may rely on distributed processing across more than one physical processor, distributed memory, etc.

Some example implementations, according to the present disclosure, are now described.

Some implementations relate to a system to aggregate issuing processor systems. The system can include a plurality of issuing processor integration interfaces. Each of the issuing processor integration interfaces can be specific to a corresponding issuing processor system of a plurality of issuing processor systems. Each issuing processor integration interface can include one or more issuer entities for card data, the card data for card creation and management within the corresponding issuing processor system. The issuer entities can be for customer data specific to the corresponding issuing processor system, and for credentials for an issuer account. The system can include one or more card records. Each card record can correspond to resources for instantiating a card, modifying functionality of the card, and managing the card. The card can be operable with a card network through an issuing processor system of the plurality of issuing processor systems. The system provides uniform receiving of data from and transmitting of data to the plurality of issuing processor systems.

In some implementations, each of the issuing processor integration interfaces is configured to receive data from and transmit data to a different respective issuing processor system in a format and comprising data specific to the respective issuing processor system. The uniform data can be received via a JSON data object of an application programming interface.

In some implementations, the one or more issuer entities include one or more issuer card data fields for card data for card creation and management within the corresponding issuing processor system. The one or more issuer entities can further include one or more issuer customer data fields for housing customer data specific to the corresponding issuing processor system. The one or more issuer entities can further include one or more issuer account data fields for housing the credentials for the issuer account.

In some implementations, the uniform receiving of data from and transmitting of data includes receiving data in a first format from a first issuing processor system of the plurality of issuing processor systems and data in a second format from a second issuing processor system of the plurality of issuing processor systems. The uniform receiving of data from and transmitting of data can further include converting the data in the first format from the first issuing processor system to a third format and the data in the second format from the second issuing processor system to the third format. The uniform receiving of data from and transmitting of data can further include transmitting, through a uniform interface, the converted data in the third format from the first issuing processor system and the second issuing processor system to a nested data structure of an electronic ledger.

In some implementations, the system can receive a first data field of an issuer entity. The system can determine a deviation between the first data field and a uniform data field of the uniform interface. Responsive to determining the deviation, the system can convey an indication to a data enricher, the indication comprising the first data field and an indication of a source of the data field, the source indicative of a location of enriched data. The system can update, responsive to a receipt of the enriched data from the data enricher, the uniform data field with the enriched data to correspond to the nested data structure.

In some implementations, the issuer entities comprise a program entity comprising one or more data fields associated with a card program. The credentials can correspond to the program entity, a user interface being configured to present, based on the receipt of the credentials. The presentation can include the one or more data fields. The presentation can include a balance of the electronic ledger associated with one or more cards associated with the card program. One or more card programs can be associated with one or more of the issuing processor systems, with the credentials corresponding to a subset of the one or more card programs.

In some implementations, the issuer entities comprise dispute resolution entities corresponding to each of the issuing processor systems. The system can generate a data field of for a dispute resolution entity. The system can provide the data field to an issuing processor according to a connection and content of the data field, based on a receipt of a uniform input and an identity of the issuing processor system.

In some implementations, a card management or creation operation, for a first subset of the issuing processor systems, uses one of the one or more issuer entities. Further according to some such implementations, no card management or creation operation, for a second subset of the issuing processor systems, uses the one of the one or more issuer entities. The system can be configured to perform two or more operations with the second subset corresponding to the card management or creation operation of the first subset. The system can be configured to uniformly receive an indication to perform the card management or creation operation between the first subset and the second subset.

In some implementations, the system includes one or more program data fields for a card program, the program data fields specifying attributes for cards issued according to the card program and a correlation to an issuing processor integration interface of the plurality of issuing processor integration interfaces.

Some implementations relate to a method to aggregate issuing processor systems. The method can be performed by one or more processors. The method can include receiving first data associated with a plurality of issuing processor integration interfaces, each specific to a corresponding issuing processor system of a plurality of issuing processor systems, each issuing processor integration interface comprising one or more issuer entities for card data for card creation and management within the corresponding issuing processor system, for customer data specific to the corresponding issuing processor system, and for credentials for an issuer account. The method can include maintaining one or more card records, each corresponding to resources for instantiating a card, modifying functionality of the card, and managing the card, wherein the card is operable with a card network through an issuing processor system of the plurality of issuing processor systems. The method can include generating, by the one or more processors, a uniform data structure for a plurality of issuer entity mappings, the plurality of issuer entity mappings corresponding to the issuing processor systems.

In some implementations, the one or more of the issuer entity mappings include a first mapping between a first data field of a first of the issuer entities and a first data field of a second of the issuer entities, the translation based on a predefined relationship between the first fields. The mappings can include a second mapping between a second data field and a third data field of the first of the issuer entities and a second data field of the second of the issuer entities. The mappings can include a third mapping between a fourth data field of the first of the issuer entities, a data enrichment source, and a fourth data field of the second of the issuer entities.

In some implementations, the method includes transmitting, by the one or more processors, based on the uniform data structure, card creation or management data to one of the issuing processor systems.

In some implementations, the method includes receiving data from a corresponding issuing processor system in a format and comprising data specific to the respective issuing processor system, the format comprising a JSON data object received over an application programming interface (API). The method can include transmitting data to the corresponding issuing processor system in the format over the API.

In some implementations, the one or more issuer entities include one or more issuer card data fields for card data for card creation and management within the corresponding issuing processor system. The issuer entities can include one or more issuer customer data fields for housing customer data specific to the corresponding issuing processor system. The issuer entities can include one or more issuer account data fields for housing the credentials for the issuer account.

In some implementations, the method includes receiving data in a first format from a first issuing processor system of the plurality of issuing processor systems and data in a second format from a second issuing processor system of the plurality of issuing processor systems. The method can include converting the data in the first format from the first issuing processor system to a third format and the data in the second format from the second issuing processor system to the third format. The method can include transmitting through a uniform interface, the converted data in the third format from the first issuing processor system and the second issuing processor system to a nested data structure of an electronic ledger.

In some implementations, the method includes receiving a first data field of an issuer entity. The method can include determining a deviation between the first data field and a uniform data field of the uniform interface. The method can include conveying an indication to a data enricher, the indication comprising the first data field and an indication of a source of the data field, the source indicative of a location of enriched data, the conveyance responsive to determining the deviation. The method can include updating responsive to a receipt of the enriched data from the data enricher, the uniform data field with the enriched data to correspond to the nested data structure.

In some implementations, the issuer entities include a program entity comprising one or more data fields associated with a card program. The method can include presenting via a user interface based on a receipt of the credentials, the one or more data fields and a balance of the electronic ledger associated with one or more cards associated with the card program. The credentials can correspond to the program entity, one or more card programs are associated with one or more of the issuing processor systems, the credentials corresponding to a subset of the one or more card programs. One or more card programs can be associated with one or more of the issuing processor systems, the credentials corresponding to a subset of the one or more card programs.

Some implementations relate to a system. The system includes an issuing processor integration interface configured to connect to a corresponding issuing processor system. The issuing processor integration interface includes a plurality of issuer entities. The issuer entities include a first issuer entity comprising first card data for card creation. The issuer entities include a second issuer entity comprising second card data for card management. The issuer entities include a third issuer entity comprising customer data specific to the corresponding issuing processor system. The issuer entities include a fourth issuer entity for credentials for an issuer account. One or more card records for a card can be operable with a card network through an issuing processor system. The card records can include first resources for instantiating a card, second resources modifying functionality of the card, and third resources for managing the card. The system provides uniform receiving of data from and transmitting of data to the issuing processor system and a plurality of further issuing processor systems.

In some implementations, the issuing processor integration interface and a multiple further issuing processor integration interfaces are configured to receive data from and transmit data to respective issuing processor systems in a format and including data specific to the respective issuing processor systems. The uniform receiving of data can be received via a JSON data object of an application programming interface.

In some implementations, the plurality of issuer entities include one or more issuer card data fields for card data for card creation and management within the corresponding issuing processor system. The plurality of issuer entities include one or more issuer customer data fields for housing customer data specific to the corresponding issuing processor system. The plurality of issuer entities include one or more issuer account data fields for housing the credentials for the issuer account.

Some implementations relate to a computer-implemented method to process exchanges. The method can be performed by one or more processors. The method can include receiving, at a plurality of issuing processor integration interfaces, exchange data for a plurality of exchanges each initiated at a point of sale by a card associated with a card network, each issuing processor integration interface of the plurality of issuing processor integration interfaces specific to a corresponding issuing processor system of a plurality of issuing processor systems, wherein each exchange of the plurality of exchanges is received at a destination for an issuing processor integration interface corresponding to a handling issuing processor system handling the exchange. For each exchange of the plurality of exchanges, the method can include parsing from the exchange data a set of exchange data for the exchange, including an exchange amount, an exchange time, and a category code. The method can include creating an exchange record according to the exchange data. For each exchange of the plurality of exchanges, the method can include determining authorization of the exchange according to at least an available balance of an account maintained in an electronic ledger. For each exchange of the plurality of exchanges, the method can include, if the exchange is authorized, clearing the exchange. For each exchange of the plurality of exchanges, the method can include transmitting the exchange record for ledger recordation, the exchange record uniform to the plurality of issuing processor integration interfaces.

In some implementations, the destination is a shared resource between one of the issuing processor integration interfaces and the corresponding issuing processor system. The computer-implemented method can further include receiving, by the one or more processors, an indication of an exchange. The computer-implemented method can further include retrieving, by the one or more processors, the exchange data. The computer-implemented method can further include associating, by the one or more processors, the retrieved exchange data with the indication of the exchange.

In some implementations, determining authorization of the exchange includes generating a uniform authorization request. Determining authorization of the exchange can further include conveying the uniform authorization request to a host for the electronic ledger. Determining authorization of the exchange can further include receiving, by the one or more processors, an indication of approval based on a ledger balance.

In some implementations, the computer-implemented method further includes identifying a portion of the exchange data lacking relevant information. The computer-implemented method can further include conveying the portion of the exchange data to an enrichment resource. computer-implemented method can further include providing enriched data corresponding to the portion of the exchange data to a host of the electronic ledger.

In some implementations, the computer-implemented method further includes clearing the exchange within a predefined time elapsed from a generation of the received exchange data.

Some implementations relate to a system to process exchanges. The system can include a plurality of issuing processor integration interfaces specific to a corresponding issuing processor system of a plurality of issuing processor systems, wherein each exchange of a plurality of exchanges is received at a destination for an issuing processor integration interface corresponding to a handling issuing processor system handling the exchange. The system can include one or more processors to receive, at the plurality of issuing processor integration interfaces, exchange data for the plurality of exchanges each initiated at a point of sale by a card associated with a card network. The system can include one or more processors to parse from the exchange data, an exchange amount, an exchange time, and a category code. The system can include one or more processors to create an exchange record according to the exchange data. The system can include one or more processors to determine authorization of the exchange according to at least an available balance of an account maintained in an electronic ledger. The system can include one or more processors to clear the exchange if the exchange is authorized. The system can include one or more processors to transmit the exchange record for ledger recordation, the exchange record uniform to the plurality of issuing processor integration interfaces.

Some implementations relate to a computer-implemented method to instantiate a card program. The computer-implemented method can be implemented by one or more processors. The computer-implemented method can include receiving, at a plurality of issuing processor integration interfaces, card information for a new card, the card information including card holder fields and a selection of a card program. The card program can correlate to an issuing processor system of a plurality of issuing processor systems. Each issuing processor integration interface of the plurality of issuing processor integration interfaces can be specific to a corresponding issuing processor system of the plurality of issuing processor systems. Each exchange of the plurality of exchanges can be received at a destination for an issuing processor integration interface corresponding to a handling issuing processor system handling the exchange. The computer-implemented method can include sending, by the issuing processor integration interface corresponding to the issuing processor system, a create card request to the issuing processor system, the create card request including card attributes. The computer-implemented method can include receiving, by the one or more processors for the issuing processor integration interface corresponding to the issuing processor system, an indication of a status of the card. The computer-implemented method can include generating, by the one or more processors, responsive to the status of the card, a unique identifier for the card. The computer-implemented method can include conveying the unique identifier to a host for an electronic ledger associated with the card.

Some implementations relate to a system to instantiate a card. The system can include a plurality of issuing processor integration interfaces each specific to a corresponding issuing processor system of a plurality of issuing processor systems, wherein each issuing processor integration interface comprises one or more issuer entities for card data for card creation and management within the corresponding issuing processor system, for customer data specific to the corresponding issuing processor system, and for credentials for an issuer account. One or more card entities can include resources for instantiating a card, modifying functionality of the card, and managing the card. The card can be operable with a card network through an issuing processor system of the plurality of issuing processors systems. The one or more processors can receive, via the communication network interface, card information for a new card, the card information including card holder fields and a selection of a card program, wherein the card program correlates to the issuing processor system of the plurality of issuing processor systems. The one or more processors can send, by the issuing processor integration interface corresponding to the issuing processor system, a create card request to the issuing processor system, the create card request including card attributes. The one or more processors can receive, by the issuing processor integration interface corresponding to the issuing processor system, an indication of a status of the card. The one or more processors can generate, responsive to the status of the card, a unique identifier for the card. The one or more processors can convey the unique identifier to a host for an electronic ledger associated with the card.

Some implementations relate to a computer-implemented method. The method can include establishing, by one or more processors, a connection with a remote computing device of a computing system connected with an issuing processor computing system; receiving, by the one or more processors from the remote computing device, one or more parameters of a card program and a pointer to a computing device of the computing system, the one or more parameters comprising an identification of the issuing processor computing system; generating, by the one or more processors, a data object for an exchange card, the data object comprising one or more data field-value pairs each corresponding to a different parameter of the one or more parameters, the data object corresponding to the issuing processor computing system; detecting, by the one or more processors, an event regarding the exchange card; and responsive to detecting the event, automatically transmitting, by the one or more processors using the pointer, a message regarding the event to the computing device of the computing system, wherein the computing device of the computing system forwards data of the message to the issuing processor computing system.

In some implementations, receiving the pointer comprises receiving, by the one or more processors, a uniform resource locator configured to operate with a webhook to communicate with the computing device of the computing system. In some implementations, receiving the pointer comprises receiving, by the one or more processors, a plurality of pointers, including the pointer, each of the plurality of pointers corresponding to a different event type. In some implementations, the event types of the plurality of pointers comprise one or more of swipe event created, swipe created, swipe updated, card created, or card status updated.

In some implementations, the method comprises determining, by the one or more processors, an event type of the detected event; and transmitting, by the one or more processors using the pointer, the message regarding the event to the computing device of the computing system responsive to the pointer corresponding to the event type. In some implementations, the method comprises receiving, by the one or more processors, a unique identifier for the exchange card; and transmitting, by the one or more processors, the unique identifier for the exchange card to the computing system, wherein the computing system is configured to receive a token for the exchange card from the issuing processor computing system; and map the token for the exchange card to the unique identifier for the exchange card.

In some implementations, receiving the unique identifier for the exchange card comprises receiving the unique identifier from a ledger computing system hosting an electronic ledger corresponding to the exchange card. The method may further comprise receiving, by the one or more processors, exchange data of a swipe event, an authorization of the swipe event, and the unique identifier for the exchange card from the computing system; and transmitting, by the one or more processors, the unique identifier with the exchange data of the swipe event to the ledger computing system based on the authorization of the swipe event. In some implementations, the ledger computing system is to identify the electronic ledger corresponding to the exchange card based on the unique identifier; and update the electronic ledger based on the exchange data of the swipe event based on the authorization of the swipe event.

In some implementations, the method further comprises presenting, by the one or more processors, a user interface at the remote computing device, the user interface comprising one or more forms configured to receive a format for communication between the one or more processors and the computing device of the computing system via the pointer; and receiving, by the one or more processors, the format as input into the one or more forms, wherein using the pointer to transmit the message regarding the event to the computing device comprises generating, by the one or more processors, the message in the format input into the one or more forms; and transmitting, by the one or more processors, the message in the format to the computing device. In some implementations, the user interface comprises a form configured to receive a type of method for communication using the pointer, the method comprising receiving, by the one or more processors, a first type of method as input via the form, wherein using the pointer to transmit the message regarding the event to the computing device comprises transmitting the message using the input first type of method.

Some implementations relate to a system. The system can include a communication network interface to interface with a communication network; a memory; and one or more processors. The one or more processors can establish a connection with a remote computing device of a computing system connected with an issuing processor computing system; receive, from the remote computing device, one or more parameters of a card program and a pointer to a computing device of the computing system, the one or more parameters comprising an identification of the issuing processor computing system; generate a data object for an exchange card, the data object comprising one or more data field-value pairs each corresponding to a different parameter of the one or more parameters, the data object corresponding to the issuing processor computing system; detect an event regarding the exchange card; and responsive to detecting the event, automatically transmit, using the pointer, a message regarding the event to the computing device of the computing system, wherein the computing device of the computing system forwards data of the message to the issuing processor computing system.

In some implementations, the one or more processors are to receive the pointer by receiving a uniform resource locator configured to operate with a webhook to communicate with the computing device of the computing system. In some implementations, the one or more processors are to receive the pointer by receiving a plurality of pointers, including the pointer, each of the plurality of pointers corresponding to a different event type. In some implementations, the event types of the plurality of pointers comprise one or more of swipe event created, swipe created, swipe updated, card created, or card status updated.

In some implementations, the one or more processors are todetermine an event type of the detected event; and transmit, using the pointer, the message regarding the event to the computing device of the computing system responsive to the pointer corresponding to the event type. In some implementations, the one or more processors are to receive a unique identifier for the exchange card; and transmit the unique identifier for the exchange card to the computing system, wherein the computing system is configured to receive a token for the exchange card from the issuing processor computing system; and map the token for the exchange card to the unique identifier for the exchange card.

In some implementations, the one or more processors are to receive the unique identifier for the exchange card by receiving the unique identifier from a ledger computing system hosting an electronic ledger corresponding to the exchange card, and the one or more processors are further to receive exchange data of a swipe event, an authorization of the swipe event, and the unique identifier for the exchange card from the computing system; and transmit the unique identifier with the exchange data of the swipe event to the ledger computing system based on the authorization of the swipe event. In some implementations, the ledger computing system is to identify the electronic ledger corresponding to the exchange card based on the unique identifier; and update the electronic ledger based on the exchange data of the swipe event based on the authorization of the swipe event.

Some implementations relate to one or more non-transitory computer-readable storage media having instructions stored thereon that, when executed by at least one processing circuit, cause the at least one processing circuit to establish a connection with a remote computing device of a computing system connected with an issuing processor computing system; receive, from the remote computing device, one or more parameters of a card program and a pointer to a computing device of the computing system, the one or more parameters comprising an identification of the issuing processor computing system; generate a data object for an exchange card, the data object comprising one or more data field-value pairs each corresponding to a different parameter of the one or more parameters, the data object corresponding to the issuing processor computing system; detect an event regarding the exchange card; and responsive to detecting the event, automatically transmit, using the pointer, a message regarding the event to the computing device of the computing system, wherein the computing device of the computing system forwards data of the message to the issuing processor computing system.

In some implementations, the instructions cause the at least one processing circuit to receive the pointer by receiving a uniform resource locator configured to operate with a webhook to communicate with the computing device of the computing system.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented and/or arranged in combination in a single implementation. Conversely, various features that are described in the context of a single implementation can also be implemented and arranged in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative implementations described under other headings; headings, where provided, are included solely for the purpose of readability, and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Having now described some illustrative implementations, implementations, illustrative embodiments, and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations, arrangements, elements, or acts of the systems and methods herein referred to in the singular may also embrace implementations including a plurality of these elements, and any references in plural to any implementation, arrangement, element, or act herein may also embrace implementations including only a single element. References in the singular or plural form are not intended to limit the presently disclosed systems or methods, or their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

It should be understood that no claim element herein is to be construed under the provisions of 35 U.S.C. § 112 (f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components, including, but not limited to, processing circuitry, network interfaces, peripheral devices, input devices, output devices, and sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps, and decision steps.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The term “coupled” and variations thereof includes the joining of two members directly or indirectly to one another. The term “electrically coupled” and variations thereof includes the joining of two members directly or indirectly to one another through conductive materials (e.g., metal or copper traces). Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical (e.g., magnetic), or fluidic.

What is claimed is:

1. A computer-implemented method, comprising:
establishing, by one or more processors, a connection with a remote computing device of a computing system connected with an issuing processor computing system;
receiving, by the one or more processors from the remote computing device, one or more parameters of a card program and a pointer to a computing device of the computing system, the one or more parameters comprising an identification of the issuing processor computing system;
generating, by the one or more processors, a data object for an exchange card, the data object comprising one or more data field-value pairs each corresponding to a different parameter of the one or more parameters, the data object corresponding to the issuing processor computing system;
detecting, by the one or more processors, an event regarding the exchange card; and
responsive to detecting the event, automatically transmitting, by the one or more processors using the pointer, a message regarding the event to the computing device of the computing system,
wherein the computing device of the computing system forwards data of the message to the issuing processor computing system.

2. The method of claim 1, wherein receiving the pointer comprises:
receiving, by the one or more processors, a uniform resource locator configured to operate with a webhook to communicate with the computing device of the computing system.

3. The method of claim 1, wherein receiving the pointer comprises receiving, by the one or more processors, a plurality of pointers, including the pointer, each of the plurality of pointers corresponding to a different event type.

4. The method of claim 3, wherein the event types of the plurality of pointers comprise one or more of swipe event created, swipe created, swipe updated, card created, or card status updated.

5. The method of claim 3, comprising:
determining, by the one or more processors, an event type of the detected event; and
transmitting, by the one or more processors using the pointer, the message regarding the event to the computing device of the computing system responsive to the pointer corresponding to the event type.

6. The method of claim 1, comprising:
receiving, by the one or more processors, a unique identifier for the exchange card; and
transmitting, by the one or more processors, the unique identifier for the exchange card to the computing system,
wherein the computing system is configured to:
receive a token for the exchange card from the issuing processor computing system; and
map the token for the exchange card to the unique identifier for the exchange card.

7. The method of claim 6, wherein receiving the unique identifier for the exchange card comprises receiving the unique identifier from a ledger computing system hosting an electronic ledger corresponding to the exchange card, and the method further comprising:
receiving, by the one or more processors, exchange data of a swipe event, an authorization of the swipe event, and the unique identifier for the exchange card from the computing system; and
transmitting, by the one or more processors, the unique identifier with the exchange data of the swipe event to the ledger computing system based on the authorization of the swipe event.

8. The method of claim 7, wherein the ledger computing system is to:
identify the electronic ledger corresponding to the exchange card based on the unique identifier; and
update the electronic ledger based on the exchange data of the swipe event based on the authorization of the swipe event.

9. The method of claim 1, comprising:
presenting, by the one or more processors, a user interface at the remote computing device, the user interface comprising one or more forms configured to receive a format for communication between the one or more processors and the computing device of the computing system via the pointer; and
receiving, by the one or more processors, the format as input into the one or more forms,
wherein using the pointer to transmit the message regarding the event to the computing device comprises:
generating, by the one or more processors, the message in the format input into the one or more forms; and
transmitting, by the one or more processors, the message in the format to the computing device.

10. The method of claim 9, wherein the user interface comprises a form configured to receive a type of method for communication using the pointer, the method comprising:
receiving, by the one or more processors, a first type of method as input via the form,
wherein using the pointer to transmit the message regarding the event to the computing device comprises transmitting the message using the input first type of method.

11. A system, comprising:
a communication network interface to interface with a communication network;
a memory; and
one or more processors, the one or more processors to:
establish a connection with a remote computing device of a computing system connected with an issuing processor computing system;
receive, from the remote computing device, one or more parameters of a card program and a pointer to a computing device of the computing system, the one or more parameters comprising an identification of the issuing processor computing system;
generate a data object for an exchange card, the data object comprising one or more data field-value pairs each corresponding to a different parameter of the one or more parameters, the data object corresponding to the issuing processor computing system;
detect an event regarding the exchange card; and
responsive to detecting the event, automatically transmit, using the pointer, a message regarding the event to the computing device of the computing system,
wherein the computing device of the computing system forwards data of the message to the issuing processor computing system.

12. The system of claim 11, wherein the one or more processors are to receive the pointer by:
receiving a uniform resource locator configured to operate with a webhook to communicate with the computing device of the computing system.

13. The system of claim 11, wherein the one or more processors are to receive the pointer by receiving a plurality of pointers, including the pointer, each of the plurality of pointers corresponding to a different event type.

14. The system of claim 13, wherein the event types of the plurality of pointers comprise one or more of swipe event created, swipe created, swipe updated, card created, or card status updated.

15. The system of claim 13, wherein the one or more processors are to:
determine an event type of the detected event; and
transmit, using the pointer, the message regarding the event to the computing device of the computing system responsive to the pointer corresponding to the event type.

16. The system of claim 11, wherein the one or more processors are to:
receive a unique identifier for the exchange card; and
transmit the unique identifier for the exchange card to the computing system,
wherein the computing system is configured to:
receive a token for the exchange card from the issuing processor computing system; and
map the token for the exchange card to the unique identifier for the exchange card.

17. The system of claim 16, wherein the one or more processors are to receive the unique identifier for the exchange card by receiving the unique identifier from a ledger computing system hosting an electronic ledger corresponding to the exchange card, and the one or more processors are further to:
receive exchange data of a swipe event, an authorization of the swipe event, and the unique identifier for the exchange card from the computing system; and
transmit the unique identifier with the exchange data of the swipe event to the ledger computing system based on the authorization of the swipe event.

18. The system of claim 17, wherein the ledger computing system is to:
identify the electronic ledger corresponding to the exchange card based on the unique identifier; and
update the electronic ledger based on the exchange data of the swipe event based on the authorization of the swipe event.

19. One or more non-transitory computer-readable storage media having instructions stored thereon that, when executed by at least one processing circuit, cause the at least one processing circuit to:
establish a connection with a remote computing device of a computing system connected with an issuing processor computing system;
receive, from the remote computing device, one or more parameters of a card program and a pointer to a computing device of the computing system, the one or more parameters comprising an identification of the issuing processor computing system;
generate a data object for an exchange card, the data object comprising one or more data field-value pairs each corresponding to a different parameter of the one or more parameters, the data object corresponding to the issuing processor computing system;
detect an event regarding the exchange card; and
responsive to detecting the event, automatically transmit, using the pointer, a message regarding the event to the computing device of the computing system,
wherein the computing device of the computing system forwards data of the message to the issuing processor computing system.

20. The one or more non-transitory computer-readable storage media of claim 19, wherein the instructions cause the at least one processing circuit to receive the pointer by:
receiving a uniform resource locator configured to operate with a webhook to communicate with the computing device of the computing system.
